(19) United States
(12) Patent Application Publication
(10) Pub. No.: US 2003/0063209 A1
(43) Pub. Date: Apr. 3, 2003

(54) Optical viewer instrument with photographing function

(75) Inventors: Shigeo Enomoto, Tokyo (JP); Shuji Yoneyama, Saitama (JP)

Correspondence Address: GREENBLUM & BERNSTEIN, P.L.C., 1950 ROLAND CLARKE PLACE, RESTON, VA, 20191, US

(73) Assignee: Asahi Kogaku Kogyo Kabushiki Kaisha, Tokyo (JP)

(21) Appl. No.: 10/255,760

(22) Filed: Sep. 27, 2002

(30) Foreign Application Priority Data
Sep. 28, 2001 (JP) P2001-301783
Jan. 23, 2002 (JP) P2002-014099

(51) Int. Cl. H04N 5/225; G02B 13/16

(52) U.S. Cl. 348/335

(57) ABSTRACT

In an optical viewer instrument with a photographing function, a telescopic lens system is used for observing an object, and a digital camera is used for photographing an object. The digital camera includes a CCD image sensor and a photographing lens system associated with each other such that the object is formed as a photographic image on the sensor through the photographing lens system. An automatically-operable focussing mechanism is associated with the photographing lens system such that the object is brought into focus through the telescopic lens system, and such that the object is brought into focus through the photographing lens system. Optical various parameters are selected such that predetermined conditions are fulfilled, whereby the focussing of the photographing lens system can be suitably and properly performed in an automatic focussing manner.

### BACKGROUND OF THE INVENTION

1. Field of the Invention

The invention relates to an optical viewer instrument with a photographing function.

2. Description of the Related Art

As is well known, an optical viewer instrument, such as a binocular telescope, a single telescope or the like, is used for watching sports, wild birds, and so on. When using such an optical viewer instrument, it is often the case that the user sees something that he or she would like to photograph. Typically, he or she will fail to photograph the desired scene because he or she must exchange a camera for the optical viewer instrument and during this time the chance is lost. For this reason, an optical viewer instrument containing a camera is proposed, whereby a photograph can be taken immediately by using the camera contained in the optical viewer instrument while continuing the observation through the optical viewer instrument.

For example, Japanese Laid-Open Utility Model Publication (KOKAI) No. 6-2330 discloses a combination of a binocular telescope and a camera, in which the camera is simply mounted on the binocular telescope. Namely, the camera is simply added to the binocular telescope, and thus the binocular telescope with the camera becomes bulky.

Of course, the binocular telescope includes a pair of telescopic lens systems, and the camera includes a photographing lens system. While an object is observed through the pair of telescopic lens systems, the observed object can be photographed by the camera. Nevertheless, the Publication No. 6-2330 does not discloses how the object, observed through the pair of telescopic lens systems, is brought into focus through the photographing lens system. Namely, since the pair of telescopic lens systems is independent from the photographing lens system, even though the object is observed as a focussed image through the pair of telescopic lens systems, it cannot be said that the observed image is brought into focus through the photographing lens system. In connection with this, it is not known whether the binocular telescope with the camera is fit for practical use, as is apparent from the disclosure of the Publication No. 6-2330.

In general, a telescopic lens system includes an objective lens system and an ocular lens system which are associated with each other, and an object at infinity is brought into focus when a rear focal point of the objective lens system and a front focal point of the ocular lens system substantially coincide with each other. Thus, to bring a near object into focus, it is necessary to relatively move the objective lens system and the ocular lens system apart from each other. Namely, a focussing mechanism must be incorporated into the telescopic lens system before the near object can be brought into focus.

For example, in a binocular telescope, the focussing mechanism is formed as a movement-conversion mechanism, having a focussing rotary wheel, which converts a rotational movement of the focussing rotary wheel into a relative translational movement between the objective lens system and the ocular lens system included in each telescopic lens system. Namely, in the binocular telescope, a near object is brought into focus by manually rotating the focussing rotary wheel.

In the binocular telescope with the camera, disclosed in the Publication No. 6-2330, both the telescopic lens systems serve as an optical view finder system for the camera, and thus an object, observed through both the telescopic lens systems, is photographed by the camera. Nevertheless, the Publication No. 6-2330 makes no reference to focussing the camera.

U.S. Pat. No. 4,067,027 discloses another type of binocular telescope containing a camera using a silver halide film. In this binocular telescope with a camera, a first focusing mechanism is incorporated in a pair of telescopic lens systems to bring an object into focus, and a second focusing mechanism is incorporated in a photographing lens system of the contained camera to bring the object into focus. The first and second focusing mechanisms have a common rotary wheel, and are operationally connected to each other so as to be operated together by manually rotating the common rotary wheel. Namely, when the object, observed through the pair of telescopic lens systems, is brought into focus by the operation of the first focussing mechanism, the observed object is focussed on a frame surface of the silver halide film through the photographing lens system by the operation of the second focussing mechanism.

While an object is observed through the pair of telescopic lens systems, the observed object must always be brought into focus through the photographing lens system, before a desirable scene can be photographed by the camera. However, as long as the focussing of the photographing lens system is performed in the manual focussing manner, it is impossible to bring the object into focus through the photographing lens system all of the time.

In general, in the field of cameras using a silver halide film, a focussing mechanism of a photographing lens system must be designed such that the degree of unsharpness of an optical image, which is obtained through the photographing lens system, falls within a permissible circle of confusion, before the optical image can be obtained as a focussed image. As is well known, the permissible circle of confusion is mainly determined by the characteristics of the photosensitive material used in the silver halide film. For example, in a 35 mm silver halide film, it is said that a diameter δ of the permissible circle of confusion is approximately 30 μm or approximately 1/1000 of a diagonal line length of a film frame, taking a human's resolution power into consideration.

Also, a focal depth of the photographing lens system is defined based on the diameter δ of the permissible circle of confusion as follows:

FOCAL DEPTH=2×δ×F

Herein: “F” represents an f-number of the photographing lens system.

Thus, an object to be photographed must be focussed within a range of the focal depth as defined above, before the photographed object can be obtained as a properly-focussed image. The focal depth of the photographing lens system is variable in accordance with the above-mentioned parameters (δ, F) and the photosensitivity of the silver halide film. Accordingly, it is necessary to suitably select values of the parameters in accordance with a desired focussing accuracy of the photographing lens system.

On the other hand, when a digital camera, using a solid-state image sensor, such as a CCD (Charge-Coupled Device) image sensor, is incorporated in an optical viewer instrument, such as a binocular telescope, a single telescope or the like, various other parameters should be taken into consideration before a focussing of the photographing lens system can be performed with the desired focussing accuracy.

In short, conventionally, it is not proposed how an optical viewer instrument with a photographing function should be designed before a focussing of the photographing lens system can be suitably and properly performed with a desired focussing accuracy in an automatic focussing manner.

### SUMMARY OF THE INVENTION

Therefore, an object of the present invention is to provide an optical viewer instrument with a photographing function, comprising a telescopic lens system and a photographing lens system, in which at least a focusing of the photographing lens system can be quickly performed with a desired focussing accuracy in an automatic focussing manner.

Another object of the invention is to provide an optical viewer instrument with a photographing function, comprising a telescopic lens system and a photographing lens system, which are constituted such that both a focussing of the telescopic lens system and a focusing of the photographing lens system can be quickly performed with a desired focussing accuracy in an automatic focussing manner.

According to a first aspect of the present invention, an optical viewer instrument with a photographing function comprises a telescopic optical system including an optical objective system, an optical erecting system, and an optical ocular system to thereby observe an object, and both the optical erecting and ocular systems are relatively movable with respect to the optical objective system along an optical axis of the telescopic optical system. A tubular shaft is rotatably provided beside the telescopic optical system, and a photographing optical system housed in the tubular shaft. A first focussing mechanism converts a rotational movement of the tubular shaft into a relative translational movement between both the optical erecting and ocular systems and the optical objective system to thereby bring the object into focus through the telescopic optical system. A second focussing mechanism converts the rotational movement of the tubular shaft into a translational movement of the photographing optical system to thereby focus the object through the photographing optical system. A driving system rotationally drives the tubular shaft and a focussing control system controls the driving system such that the focussing of the object through the photographing optical system is automatically performed.

The optical viewer instrument with the photographing function may further comprise a solid-state image sensor arranged behind and aligned with the photographing optical system such that the object is focussed on a light-receiving surface of the solid-state image sensor. In this case, preferably, the optical viewer instrument with the photographing function is constituted such that the following conditions are fulfilled:

y²/[1000×PF(ω/T)²]>80 and F<6

Herein:

“F” represents an f-number of the photographing optical system;

“y” represents a maximum image height (mm) of the solid-state image sensor, which is defined as one-half of a diagonal line length of the light-receiving surface of the solid-state image sensor;

“ω” represents a half field angle (rad) of the telescopic optical system;

“T” represents a field ratio of the half field angle “ω” to a half field angle “θ” (rad) of the photographing optical system (T=ω/θ); and

“P” represents a pixel pitch of the solid-state image sensor.

The focussing control system may comprise a first calculation system that successively calculates a difference between brightness levels of two consecutive digital image-pixel signals derived from a predetermined area of one image frame defined by the solid-state image sensor, a second calculation system that calculates a total value of all differences obtained by the first calculation system, a calculation operation system that repeatedly operates the first and second calculation systems such that the total value is successively obtained from the second calculation system during the translational movement of the photographing optical system by the driving system, a comparison system that compares a last calculated total value, i.e. the total value calculated most recently, obtained from the second calculation system, with a penultimate total value, i.e. the total value calculated just before the last total value, obtained from the second calculation system to determine whether the last total value is less than the penultimate total value, and a stopping system that stops the driving system to end the translational movement of the photographing optical system when the last total value is less than the penultimate total value.

Optionally, the focussing control system may comprise a distance measurement detecting system that detects the distance of an object measured from the optical viewer instrument with the photographing function to the object, a calculation system that calculates a focussed position of the photographing optical system, corresponding to the object distance detected by the distance measurement detecting system, a position detecting system that detects the position of the photographing optical system along a path for the translational movement thereof, a starting system that starts the driving system to translationally move the photographing optical system toward the focussed position calculated by the calculation system, and a stopping system that stops the driving system to end the translational movement of the photographing optical system when the arrival of the photographing optical system at the focussed position is detected by the position detecting system.

There may be a first telescopic optical system and a second telescopic optical system as a substitute for the aforesaid telescopic optical system. In this case, each of the first and second telescopic optical system includes an optical objective system, an optical erecting system, and an optical ocular to thereby observe an object, and both the optical erecting and ocular systems are relatively movable with respect to the optical objective system along an optical axis of the second telescopic optical system. The tubular shaft is rotatably provided between the first and second telescopic optical systems, and the first focussing mechanism converts the rotational movement of the tubular shaft into a relative translational movement between both the optical erecting and ocular systems, included in each telescopic optical system, and the optical objective system, included in each telescopic optical system, to thereby bring the object into focus through the first and second telescopic optical systems.

The optical viewer instrument with the photographing function may comprise a casing that accommodates the first and second telescopic optical systems. The casing may include two casing sections movably engaged with each other, and the respective first and second telescopic optical systems are assembled in the casing sections such that a distance between the optical axes of the first and second telescopic optical systems is adjustable by relatively moving one of the casing sections with respect to the remaining casing section. Preferably, one of the casing sections is slidably engaged in the remaining casing section such that the optical axes of the first and second telescopic optical systems are movable in a common geometric plane by relatively sliding one of the casing sections with respect to the remaining casing section.

Optionally, the optical viewer instrument with a photographing function may comprise a pair of barrel members that accommodate the first and second telescopic optical systems, respectively, and that are rotatable around a central axis of the tubular shaft to adjust a distance between the optical axes of the first and second telescopic optical systems. Preferably, the objective optical system, included in one of the first and second telescopic optical systems, forms a part of the photographing optical system, and the barrel member accommodating the objective optical system forming the part of the photographing optical system is constituted such that a part of a light beam, passing through the objective optical system forming the part of the photographing optical system, is introduced into the photographing optical system.

According to a second aspect of the present invention, an optical viewer instrument with a photographing function comprises a telescopic optical system for observing an object, and a digital camera system including a photographing optical system, and a solid-state image sensor arranged behind and aligned with the photographing optical system. A focussing mechanism is associated with the photographing optical system to translationally move the photographing optical system such that the object is formed as a photographic image on a light-receiving surface of the solid-state image sensor through the photographing optical system, and an automatic control system automatically operates the focussing mechanism such that the object is brought into focus through the photographing optical system in an automatic focussing manner. The optical viewer instrument with the photographing function is constituted such that the following conditions are fulfilled:

y²/[1000×PF(ω/T)²]>80 and F<6

Herein:

“F” represents an f-number of the photographing optical system;

“y” represents a maximum image height (mm) of the solid-state image sensor, which is defined as one-half of a diagonal line length of the light-receiving surface of the solid-state image sensor;

“ω” represents a half field angle (rad) of the telescopic optical system;

“T” represents a field ratio of the half field angle “ω” to a half field angle “θ” (rad) of the photographing optical system (T=ω/θ); and

“P” represents a pixel pitch of the solid-state image sensor.

In the second aspect of the present invention, the automatic control system may comprise a driving system that operates the focussing mechanism to cause the translational movement of the photographing optical system, a first calculation system that successively calculates a difference between brightness levels of two consecutive digital image-pixel signals derived from a predetermined area of one image frame defined by the solid-state image sensor, a second calculation system that calculates a total value of all differences obtained by the first calculation system, a calculation operation system that repeatedly operates the first and second calculation systems such that the total value is successively obtained from the second calculation system during the translational movement of the photographing optical system by the driving system, a comparison system that compares a last total value, i.e. the total value calculated most recently, obtained from the second calculation system, with a penultimate total value, i.e. the total value calculated just before the last calculated total value, obtained from the second calculation system to determine whether the last total value is less than the penultimate total value, and a stopping system that stops the driving system to end the translational movement of the photographing optical system when the last total value is less than the penultimate total value.

Optionally, the automatic control system may comprise a driving system that operates the focussing mechanism to cause the translational movement of the photographing optical system, a distance measurement detecting system that detects an object distance measured from the optical viewer instrument with the photographing function to the object, a calculation system that calculates a focussed position of the photographing optical system, corresponding to the object distance detected by the distance measurement detecting system, a position detecting system that detects a position of the photographing optical system along a path for the translational movement thereof, a starting system that starts the driving system to translationally move the photographing optical system toward the focussed position calculated by the calculation system, and a stopping system that stops the driving system to end the translational movement of the photographing optical system when an arrival of the photographing optical system at the focussed position is detected by the position detecting system.

In the second aspect of the present invention, the optical viewer instrument with the photographing function may further comprise a focussing mechanism associated with the telescopic optical system such that the object is brought into focus through the telescopic optical system, and the focussing mechanism for the telescopic optical system is operationally connected to the focussing mechanism for the photographing optical system such that a focussing of the telescopic optical system is automatically performed.

The focussing mechanism for the photographing optical system may be formed as a movement-conversion mechanism that converts a rotational movement into the translational movement of the photographing optical system such that either a linear relationship or a nonlinear relationship is established between the rotational movement and the translational movement.

In accordance with a third aspect of the present invention, there is provided a binocular telescope with a photographing function, which comprises a pair of telescopic optical systems for observing an object, and each of the telescopic optical systems includes an optical objective system, an optical erecting system, and an optical ocular system. Both the optical erecting and ocular systems are relatively movable with respect to the optical objective system along an optical axis of the corresponding telescopic optical system. A tubular shaft is rotatably provided between the telescopic optical systems, and a digital camera system includes a photographing optical system housed in the tubular shaft, and a solid-state image sensor arranged behind and aligned with the photographing optical system. A first focussing mechanism is associated with the pair of telescopic optical systems and the tubular shaft such that a rotational movement of the tubular shaft is converted into a relative translational movement between both the optical erecting and ocular systems, included in each telescopic optical system, and the optical objective system, included in each telescopic optical system, to thereby bring the object into focus through the pair of telescopic optical systems. A second focussing mechanism is associated with the photographing optical system and the tubular shaft such that the rotational movement of the tubular shaft is converted into a translational movement of the photographing optical system with respect to a light-receiving surface of the solid-state image sensor, thereby focussing the object on the light-receiving surface of the solid-state image sensor. An automatic control system automatically operates the second focussing mechanism such that the object is brought into focus through the photographing optical system in an automatic focussing manner. The binocular telescope with the photographing function is constituted such that the following conditions are fulfilled:

y²/[1000×PF(ω/T)²]>80 and F<6

Herein:

“F” represents an f-number of the photographing optical system;

“y” represents a maximum image height (mm) of the solid-state image sensor, which is defined as one-half of a diagonal line length of the light-receiving surface of the solid-state image sensor;

“ω” represents a half field angle (rad) of the telescopic optical system;

“T” represents a field ratio of the half field angle “ω” to a half field angle “θ” (rad) of the photographing optical system (T=ω/θ); and

“P” represents a pixel pitch of the solid-state image sensor.

In the binocular telescope with the photographing function, the automatic control system may comprise a driving system that operates the focussing mechanism to thereby cause the translational movement of the photographing optical system, a first calculation system that successively calculates a difference between brightness levels of two consecutive digital image-pixel signals derived from a predetermined area of one image frame defined by the solid-state image sensor, a second calculation system that calculates a total value of all differences obtained from the first calculation system, a calculation operation system that repeatedly operates the first and second calculation systems such that the total value is successively obtained from the second calculation system during the translational movement of the photographing optical system by the driving system, a comparison system that compares a last total value, i.e. the total value calculated most recently, obtained from the second calculation system, with a penultimate total value, i.e. the total value calculated just before the last calculated total value, obtained from the second calculation system to determine whether the last total value is less than the penultimate total value, and a stopping system that stops the driving system to end the translational movement of the photographing optical system when the last total value is less than the penultimate total value.

Optionally, the automatic control system may comprise a driving system that operates the focussing mechanism to thereby cause the translational movement of the photographing optical system, a distance measurement detecting system that detects an object distance measured from the optical viewer instrument with the photographing function to the object, a calculation system that calculates a focussed position of the photographing optical system, corresponding to the object distance detected by the distance measurement detecting system, a position detecting system that detects a position of the photographing optical system along a path for the translational movement thereof, a starting system that starts the driving system to translationally move the photographing optical system toward the focussed position calculated by the calculation system, a stopping system that stops the driving system to end the translational movement of the photographing optical system when the arrival of the photographing optical system at the focussed position is detected by the position detecting system.

Preferably, in the binocular telescope with the photographing function, the first focussing mechanism for the pair of telescopic optical systems is operationally connected to the second focussing mechanism for the photographing optical system such that a focussing of the pair of telescopic optical systems is automatically performed.

In the binocular telescope with the photographing function, the second focussing mechanism for the photographing optical system may be formed as a movement-conversion mechanism that converts the rotational movement of the tubular shaft into the translational movement of the photographing optical system such that either a linear relationship or a nonlinear relationship is established between the rotational movement of the tubular shaft and the translational movement of the photographing optical system.

The binocular telescope with the photographing function may comprise a casing that receives the pair of telescopic optical systems. The casing may include two casing sections movably engaged with each other, and the respective telescopic optical systems are assembled in the casing sections such that a distance between the optical axes of the telescopic optical systems is adjustable by relatively moving one of the casing sections with respect to the remaining casing section. Preferably, one of the casing sections is slidably engaged in the remaining casing section such that the optical axes of the first and second telescopic optical systems are movable in a common geometric plane by relatively sliding one of the casing sections with respect to the remaining casing section.

Optionally, the binocular telescope with the photographing function may comprise a pair of barrel members that accommodate the respective telescopic optical systems, and that are rotatable around a central axis of the tubular shaft to adjust a distance between the optical axes of the telescopic optical systems. In this case, preferably, the objective optical system, included in one of the telescopic optical systems, forms a part of the photographing optical system, and the barrel member accommodating the objective optical system forming the part of the photographing optical system is constituted such that a part of a light beam, passing through the objective optical system forming the part of the photographing optical system, is introduced into the photographing optical system.

### BRIEF DESCRIPTION OF THE DRAWINGS

The objects and other objects of the invention will be better understood from the following descriptions, with reference to the accompanying drawings, in which:

FIG. 1 is a cross-sectional plan view of a first embodiment of a binocular telescope containing a digital camera according to the present invention;

FIG. 2 is a cross-sectional view taken along line II-II of FIG. 1, in which a movable casing section is shown at a retracted position with respect to a main casing section;

FIG. 3 is a cross-section view, similar to FIG. 2, in which the movable casing section is shown at an extended position with respect to a main casing section;

FIG. 4 is a plan view of a support-plate assembly housed in a casing formed by the main and movable casing sections;

FIG. 5 is a plan view of the right and left mount plates arranged above the support-plate assembly;

FIG. 6 is an elevational view observed along line VI-VI of FIG. 5;

FIG. 7 is a cross-sectional view taken along line VII-VII of FIG. 1;

FIG. 8 is a cross-sectional view, similar to FIG. 7, showing a modification of the embodiment shown in FIGS. 1 to 7;

FIG. 9 is a control block diagram for the first embodiment of the binocular telescope with the digital camera shown in FIGS. 1 to 8;

FIG. 10 is a flowchart of an AF operation routine executed in the microcomputer shown in FIG. 9;

FIG. 11 is a cross-sectional plan view, similar to FIG. 1, showing a second embodiment of the binocular telescope with the digital camera according to the present invention;

FIG. 12 is a control block diagram for the second embodiment of the binocular telescope with the digital camera shown in FIG. 11;

FIG. 13 is a flowchart of an AF operation routine executed in the microcomputer shown in FIG. 12;

FIG. 14 is a control block diagram, similar to FIG. 12, showing a first modification of the second embodiment of the binocular telescope with the digital camera;

FIG. 15 is a flowchart of an AF operation routine executed in the microcomputer shown in FIG. 14;

FIG. 16 is a cross-sectional plan view, similar to FIG. 1, showing a second modification of the second embodiment of the binocular telescope with the digital camera;

FIG. 17 is a schematic cross-sectional plan view showing a third embodiment of the binocular telescope with the digital camera according to the present invention; and

FIG. 18 is cross-sectional view taken along line XVIII-XVIII of FIG. 17.

### DESCRIPTION OF THE PREFERRED EMBODIMENTS

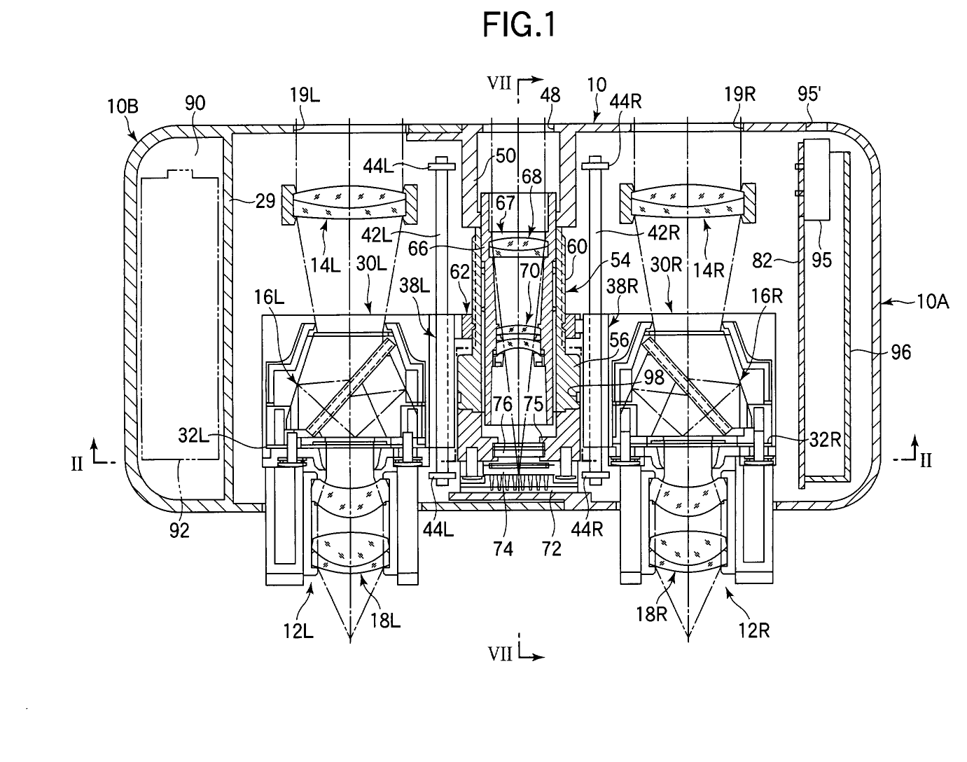

FIGS. 1 to 7 show a first embodiment of an optical viewer instrument with a photographing function according to the present invention, which is constituted as a binocular telescope with a digital camera.

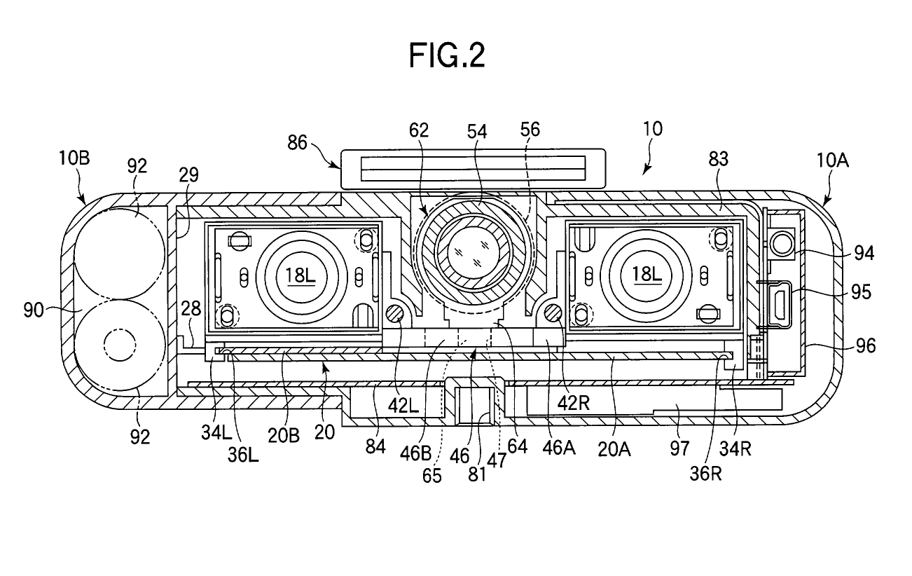

First, with reference to FIG. 1, an inner arrangement of the binocular telescope containing the digital camera is shown, and FIG. 2 shows a cross-section taken along line II-II of FIG. 1. As shown in these drawings, the binocular telescope with the digital camera comprises a casing 10 including a main casing section 10A and a movable casing section 10B, and a pair of telescopic lens systems 12R and 12L housed in the casing 10, that are optically identical to each other. The respective telescopic lens systems 12R and 12L are provided for the right and left eyes of a human, and are symmetrically arranged with respect to a middle line therebetween.

The right telescopic lens system 12R is assembled in the main casing section 10A, and includes an objective lens system 14R, an erecting prism system 16R, and an ocular lens system 18R. A front wall of the main casing section 10A is formed with a window 19R, which is aligned with the objective lens system 14R of the right telescopic lens system.

The left telescopic lens system 12R is assembled in the movable casing section 10B, and includes an objective lens system 14L, an erecting prism system 16 L, and an ocular lens system 18L. A front wall of the movable casing section 10B is formed with a window 19L, which is aligned with the objective lens system 14L of the left telescopic lens system.

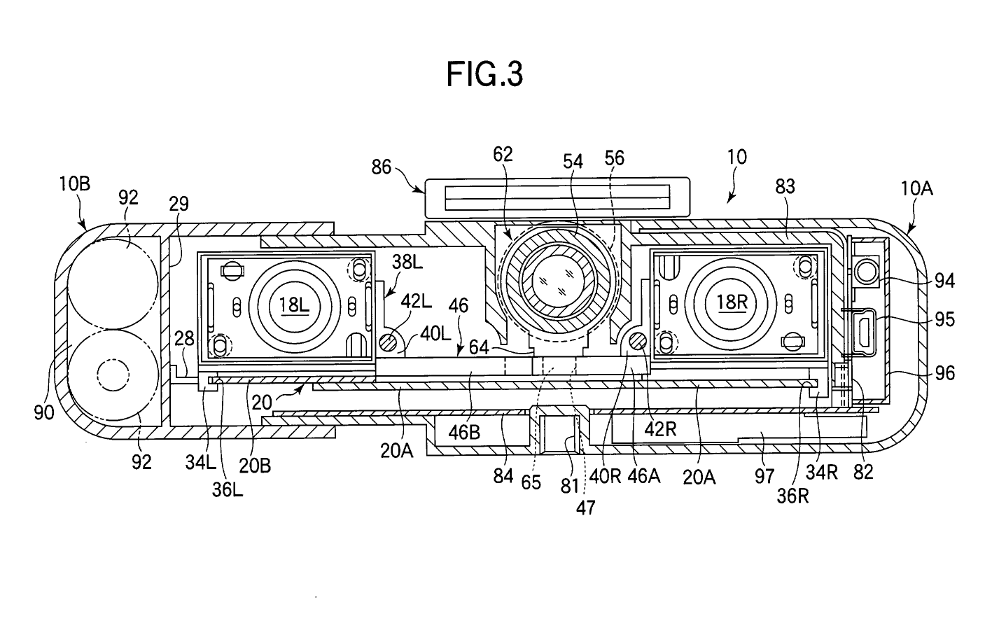

The movable casing section 10B is slidably engaged with the main casing section 10A, such that they are relatively moved from each other. Namely, the movable casing section 10B can be moved in relation to the main casing section 10A between a retracted position as shown in FIG. 2 and a maximum-extended position as shown in FIG. 3.

A suitable friction force acts on the sliding surfaces of both the casing sections 10A and 10B, and thus a certain extension force must be exerted on the movable casing section 10B before the movable casing section 10B can be extended from the main casing section 10A. Similarly, a certain extraction force must be exerted on the movable casing section 10B before the movable casing section 10B can be retracted onto the main casing section 10A. Thus, it is possible to stay and hold the movable casing section 10B still at an optional position between the retracted position (FIG. 2) and the maximum-extended position (FIG. 3), due to the suitable friction force acting on the sliding surfaces of both the casing sections 10A and 10B.

As is apparent from FIGS. 2 and 3, when the movable casing section 10B is extended from the main casing section 10A, the left telescopic lens system 12L is moved together with the movable casing section 10B, but the right telescopic lens system 12R stays in the main casing section 10A. Thus, by extending the movable casing section 10B from the main casing section 10A, it is possible to adjust a distance between the optical axes of the right and left telescopic lens systems 12R and 12L such that the distance can coincide with an interpupillary distance of a user. Namely, it is possible to perform the interpupillary adjustment by relatively sliding the movable casing section 10B in relation to the main casing section 10A.

In this embodiment, the objective lens system 14R of the right telescopic lens system 12R is held at a fixed position with respect to the main casing section 10A, but both the erecting prism system 16R and the ocular lens system 18R is movable back and forth with respect to the objective lens system 14R, whereby an object to be observed through the right telescopic lens system 12R is brought into focus. Similarly, the objective lens system 14L of the left telescopic lens system 12L is held at a fixed position with respect to the movable casing section 10B, but both the erecting prism system 16L and the ocular lens system 18L are movable back and forth with respect to the objective lens system 14L, whereby an object to be observed through the left telescopic lens system 12L is brought into focus.

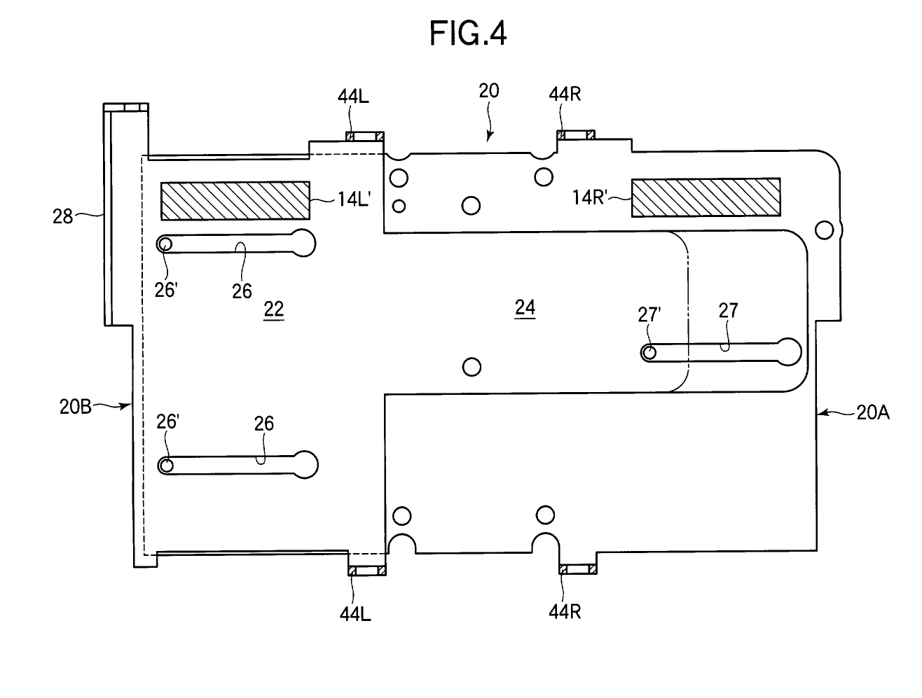

For the purpose of both the interpupillary adjustment and the focussing of the right and left telescopic lens systems 12R and 12L, the casing 10 is provided with a support-plate assembly 20, as shown in FIG. 4, and the right and left telescopic lens systems 12R and 12L are mounted on the support-plate assembly 20 in a manner stated in detail hereinafter. Note, in FIG. 1, although the support-plate assembly 20 is visible, it is not shown, in order to avoid an overly complex illustration.

As shown in FIG. 4, the support-plate assembly 20 comprises a rectangular plate member 20A, and a slide plate member 20B slidably laid on the rectangular plate member 20A. The rectangular plate member 20A has a longitudinal length, and a lateral length shorter than the longitudinal length. The slide plate member 20B includes a rectangular section 22 having a width substantially equal to the lateral length of the rectangular plate member 20A, and a section 24 integrally extended from the section 22, both the sections 22 and 24 having a longitudinal length substantially equal to the longitudinal length of the rectangular plate member 20A.

The slide plate member 20B is provided with a pair of guide slots 26 formed in the rectangular section 22, and a guide slot 27 formed in the extended section 24. On the other hand, a pair of stub elements 26′ and a stub element 27′ are securely attached to the rectangular plate member 20A, such that the pair of stub elements 26′ is slidably received in the pair of guide slots 26, and that the stub element 27′ is slidably received in the guide slot 27. The guide slots 26 and 27 are extended in parallel to each other, and each slot has a length corresponding to the movement distance of the movable casing section 10B between the retracted position (FIG. 2) and the maximum-extended position (FIG. 3).

As shown in FIGS. 2 and 3, the support-plate assembly 20 is arranged in the casing 10 so as to be spaced apart from the bottom of the casing 10. The rectangular plate member 20A is securely connected to the main casing section 10A in a suitable manner. The slide plate member 20B has a protrusion 28 integrally protruded from rectangular section 22, and the protrusion 28 is securely connected to a partition 29 provided in the movable casing section 10B, as shown in FIGS. 2 and 3. Thus, when the movable casing section 10B is moved with respect to the main casing section 10A, the slide plate member 20B can be moved together with the movable casing section 10B.

The objective lens system 14R of the right telescopic lens system 12R is securely fixed on the rectangular plate member 20A at a hatched area indicated by reference 14R′, and the objective lens system 14L of the left telescopic lens system 12L is securely fixed on the rectangular section 22 of the slide plate member 20B at a hatched area indicated by reference 14L′.

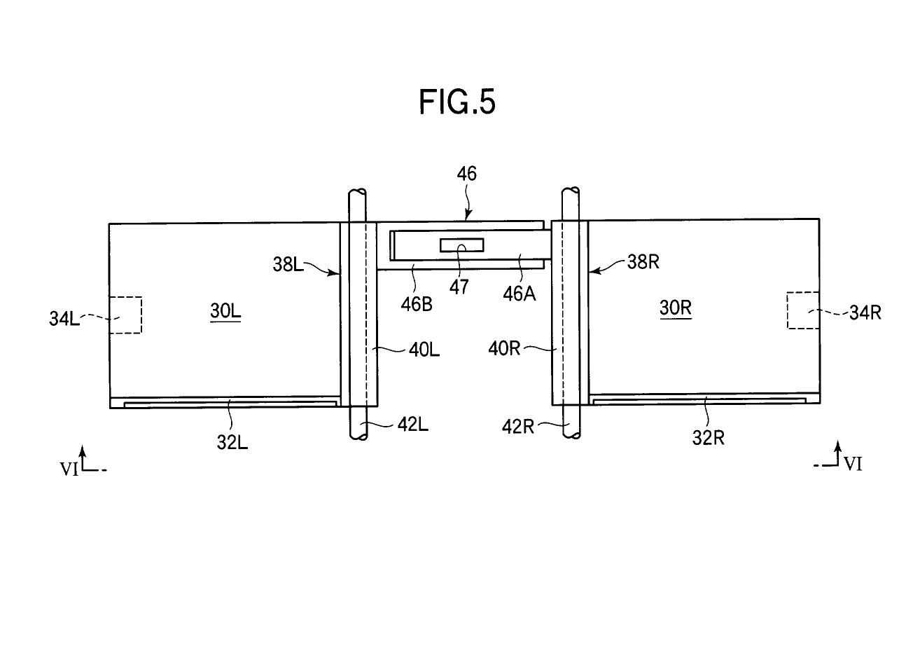

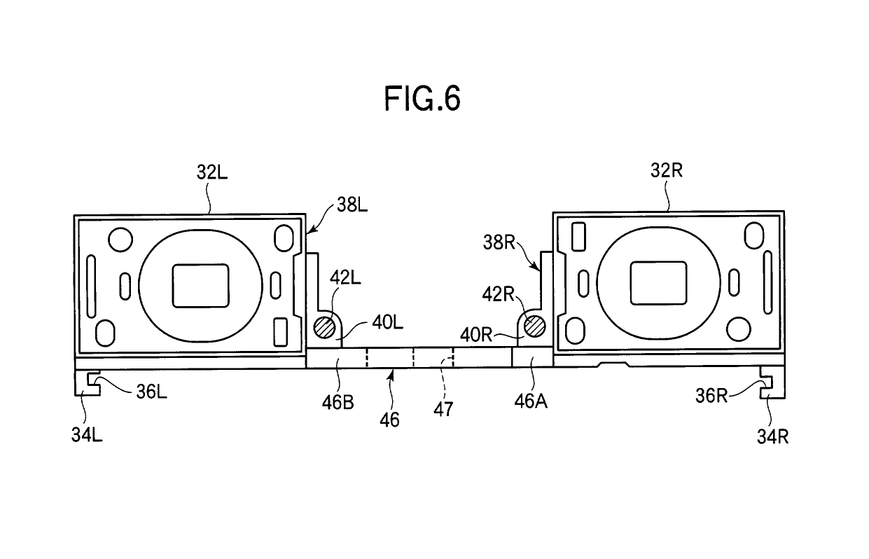

FIG. 5 shows right and left mount plates 30R and 30L arranged above the support-plate assembly 20, and the respective erecting prism systems 16R and 16L are mounted on the right and left mount plates 30R and 30L, as shown in FIG. 1. Also, as is apparent from FIGS. 5 and 6, the respective right and left mount plate 30R and 30L have upright plates 32R and 32L provided along rear side edges thereof, and the respective ocular lens systems 18R and 18L are attached to the upright plates 32R and 32L, as shown in FIG. 1.

The right mount plate 30R is movably supported by the rectangular plate member 20A such that both the erecting prism system 16R and the ocular lens system 18R is movable back and forth with respect to the objective lens system 14R. Similarly, the left mount plate 30L is movably supported by the slide plate member 20B such that both the erecting prism system 16L and the ocular lens system 18L is movable back and forth with respect to the objective lens system 14L.

In particular, the right mount plate 30R is provided with a guide shoe 34R secured to the underside thereof in the vicinity of the right side edge thereof, as shown in FIGS. 5 and 6. The guide shoe 34R is formed with a groove 36R (FIG. 6), which slidably receives a right side edge of the rectangular plate member 20A, as shown in FIGS. 2 and 3. Also, the right mount plate 30R has a side wall 38R provided along a left side edge thereof, and a lower portion of the side wall 38R is formed as a swollen portion 40R having a through bore for slidably receiving a guide rod 42R. The ends of the guide rod 42R are securely supported by a pair of fixture pieces 44R integrally protruded from the rectangular plate member 20A (FIGS. 1 and 4). Thus, the right mount plate 30R, carrying both the erecting prism system 16R and the ocular lens system 18R, is translationally movable back and forth with respect to the objective lens system 14R.

Similarly, the left mount plate 30L is provided with a guide shoe 34L secured to the underside thereof in the vicinity of the left side edge thereof, as shown in FIGS. 5 and 6. The guide shoe 34L is formed with a groove 36L (FIG. 6), which slidably receives a left side edge of the slide plate member 20B, as shown in FIGS. 2 and 3. Also, the left mount plate 30L has a side wall 38L provided along a right side edge thereof, and a lower portion of the side wall 38L is formed as a swollen portion 40L having a through bore for slidably receiving a guide rod 42L. The ends of the guide rod 42L are securely supported by a pair of fixture pieces 44L integrally protruded from the slide plate member 20B (FIGS. 1 and 4). Thus, the left mount plate 30L, carrying both the erecting prism system 16L and the ocular lens system 18L, is translationally movable back and forth with respect to the objective lens system 14L.

Note, as stated above, although the support-plate assembly 20 is not shown in FIG. 1, only the fixture pieces 44R and 44L are illustrated.

With the above-mentioned arrangement, it is possible to perform the interpupillary adjustment of the right and left telescopic lens systems 12R and 12L by moving the movable casing section 10B from and toward the main casing section 10A. Further, it is possible to perform the focussing of the right telescopic lens system 12R by translationally moving the mount plate 30R back and forth with respect to the objective lens system 14R, and it is possible to perform the focussing of the left telescopic lens system 12L by translationally moving the mount plate 30L back and forth with respect to the objective lens system 14L.

In order to simultaneously move the right and left mount plates 30R and 30L such that a distance between the right and left mount plates 30R and 30L is variable, the mount plates 30R and 30L are interconnected to each other by an expandable coupler 46.

In particular, as best shown in FIG. 5, the expandable coupler 46 includes a rectangular lumber-like member 46A, and a forked member 46B in which the lumber-like member 46A is slidably received. The lumber-like member 46A is securely attached to the underside of the swollen portion 40R of the side wall 38R at the forward end thereof, and the forked member 46B is securely attached to the underside of the swollen portion 40L of the side wall 38L at the forward end thereof. Both the members 46A and 46B has a sufficient length which is more than the movement distance of the movable casing section 10B between the retracted position (FIG. 2) and the maximum-extended position (FIG. 3). Namely, even though the movable casing section 10B is extended from the retracted position (FIG. 2) to the maximum-extended position (FIG. 3), the slidable engagement is maintained between the members 46A and 46B. Thus, the simultaneous translational movement of both the mount plates 30R and 30L, and therefore, both the right optical system (16R, 18R) and the left optical system (16L, 18L) mounted thereon, can be assured at all times.

Note, as best shown in FIG. 5, the lumber-like member 46A is formed with a rectangular bore 47, which is utilized for a purpose stated hereinafter.

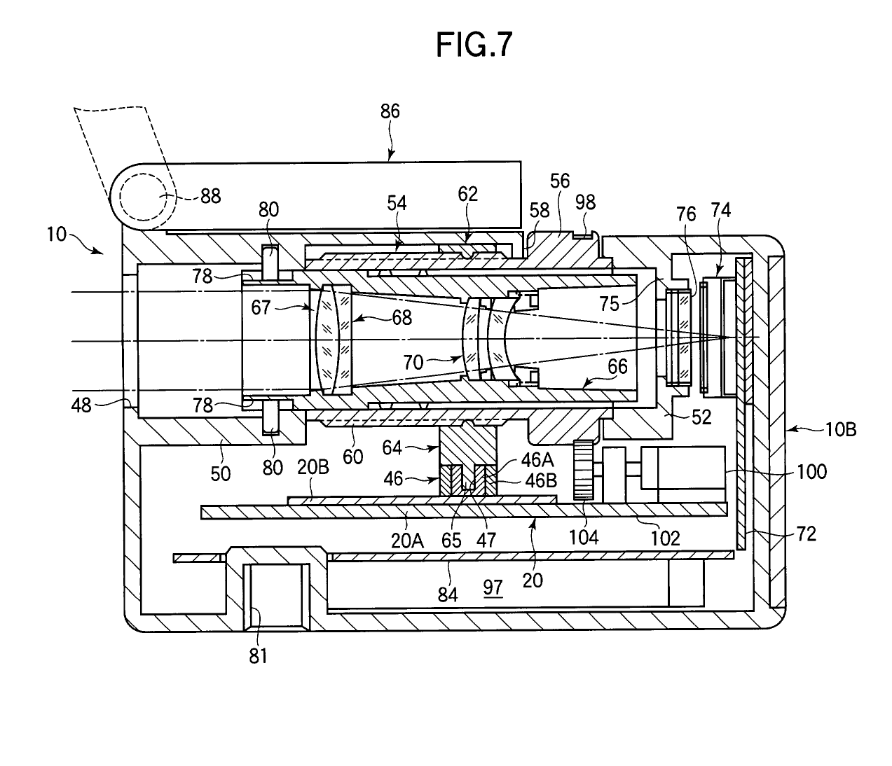

FIG. 7 shows a cross-section taken along line VII-VII of FIG. 1. As is apparent from FIGS. 1 and 7, the main casing section 10A has a circular window 48 formed in the front wall thereof, and the circular window 48 is at a center position of the front wall of the casing 10 when the movable casing section 10B is positioned at the retracted position (FIG. 2).

As shown in FIGS. 1 and 7, the main casing section 10A has an inner front sleeve member 50 integrally protruded from the inner wall surface of the front wall thereof to surround the circular window 48, and the inner front sleeve member 50 is integrated with the top wall of the main casing section 10A. Also, an inner rear sleeve member 52 is integrally suspended from the top wall of the main casing section 10A, and is aligned with the inner front sleeve member 50.

A tubular shaft 54 is rotatably provided between and supported by the inner front and rear sleeve members 50 and 52, and has a rotary wheel 56 integrally formed therewith. As shown in FIG. 7, a rectangular opening 58 is formed in the top wall of the main casing section 10A, a portion of the rotary wheel 56 is exposed to outside through the rectangular opening 58. Thus, it is possible to rotate the tubular shaft 54 by manually driving the exposed portion of the rotary wheel 56 with a user's finger.

The tubular shaft 54 has a male screw 60 formed around the outer peripheral wall surface thereof between the front end thereof and the rotary wheel 56, and an annular member 62 is threaded onto the male screw 60 of the tubular shaft 54. As shown in FIGS. 2, 3, and 7, the annular member 62 has a radial extension 64 integrally formed therewith, and a rectangular projection 65 is integrally projected from the radial extension 64. The rectangular projection 65 is inserted and fitted into the rectangular bore 47 formed in the lumber-like member 46A of the expandable coupler 46.

With the above-mentioned arrangement, while the tubular shaft 54 is rotated by manually driving the rotary wheel 56, the annular member 62 is moved along the longitudinal central axis of the tubular shaft 54, resulting in the simultaneous translational movement of both the mount plates 30A and 30B, and therefore, both the right optical system (16R, 18R) and the left optical system (16L, 18L) mounted thereon. Namely, the tubular shaft 54 and the annular 62, which are threadedly engaged with each other, form a movement-conversion mechanism for converting the rotational movement of the rotary wheel 56 into the translational movement of both the right optical system (16R, 18R) and the left optical system (16L, 18L), and the movement-conversion mechanism is utilized as a focussing mechanism for both the right and left telescopic lens systems 12R and 12L.

Each of the right and left telescopic lens systems 12R and 12L is optically designed such that an object at infinity is brought into focus when both the erecting lens system (16R, 16L) and the ocular lens system (18R, 18L) are closest to the corresponding objective lens system (14R, 14L). Accordingly, before a near object can be brought into focus, it is necessary to move both the erecting lens system (16R, 16L) and the ocular lens system away from the corresponding objective lens system (14R, 14L). When both the erecting lens system (16R, 16L) and the ocular lens system are farthest from the corresponding objective lens system (14R, 14L), it is possible to bring a nearest object into focus.

As best shown in FIGS. 1 and 7, a lens barrel 66 is provided within the tubular shaft 54, and a photographing lens system 67 including a first lens system 68 and a second lens system 70 is held in the lens barrel 66. On the other hand, an image-sensor control circuit board 72 is securely attached to the inner wall surface of the rear wall of the main casing section 10A, and a CCD image sensor 74 is mounted on the image-sensor control circuit board 72 such that a light-receiving surface of the CCD image sensor 74 is aligned with the photographing lens system 67 held in the lens barrel 66. The inner rear sleeve member 52 has an inner annular flange 75 formed at the rear end thereof, and an optical low-pass filter 76 is fitted into the inner annular flange 75. In short, the photographing lens system 67, the CCD image sensor 74, and the optical low-pass filter 76 form a digital camera, and an object to be photographed is focussed on the light-receiving surface of the CCD image sensor 74 through the photographing lens system 67 and the optical low-pass filter 76.

Note, according to the present invention, the focussing of the photographing lens system 67 is automatically performed as discussed hereinafter.

For example, before a nearest object, which is situated 1.0 meters ahead of the digital camera, can be photographed as a focussed image, similar to a case of a usual digital camera, a focussing mechanism must be incorporated into the photographing lens system 67. Further, it is preferable to operationally connect and link the focussing mechanism for the photographing lens system 67 to the focussing mechanism for the right and left telescopic lens systems 12R and 12L, because the telescopic lens systems 12R and 12L are utilized as a view finder system for the contained digital camera. Namely, when an object is automatically focussed on the light receiving surface of the CCD image sensor 74 through the photographing lens system 67, the object should be observed as a focussed image through the right and left telescopic lens systems 12R and 12L.

To this end, respective female and male screws are formed around the inner peripheral wall surface of the tubular shaft 54 and the outer peripheral wall surface of the lens barrel 66, such that the lens barrel 66 is in threaded-engagement with the tubular shaft 54. The front end portion of the lens barrel 66 is inserted into the inner front sleeve member 50, and a pair of key grooves 78 is diametrically formed in the front end portion of the lens barrel 66, each of the key grooves 78 extending over a predetermined distance measured from the front end edge thereof. On the other hand, two bores are diametrically formed in the inner wall of the inner front sleeve member 50, and two pin elements 80 are planted in the bores so as to be engaged in the key grooves 78, as shown in FIG. 7, thereby preventing a rotational movement of the lens barrel 55.

Accordingly, when the tubular shaft 54 is rotated, the lens barrel 66 is translationally moved along the optical axis of the photographing lens system 67 due to the threaded-engagement between the tubular shaft 54 and the lens barrel 66. Namely, the female and male screws, formed around the inner peripheral wall surface of the tubular shaft 54 and the outer peripheral wall surface of the lens barrel 66, constitutes a movement-conversion mechanism for converting the rotational movement of the rotary wheel 56 into the translational movement of the lens barrel 66, and the movement-conversion mechanism is utilized as the focussing mechanism for the photographing lens system 67.

The male screw 60, formed around the outer peripheral surface of the tubular shaft 54, is formed as a reversed screw with respect to the female screw formed around the inner peripheral surface of the tubular shaft 54. Accordingly, when both the erecting prism system (16R, 16L) and the ocular lens system (18R, 18L) are rearward moved away from the corresponding objective lens system (14R, 14L), the lens barrel 66 is forward moved away from the CCD image sensor 74. Thus, when the rearward movement of both the erecting prism system (16R, 16L) and the ocular lens system (18R, 18L) are performed so as to bring a near object into focus in the telescopic lens system (12R, 12L), it is possible to focus the observed near object on the light-receiving surface of the CCD image sensor 74 due to the forward movement of the lens barrel 66, and therefore, the photographing lens system 67.

Note, of course, the male screw 60, formed around the outer peripheral surface of the tubular shaft 54, exhibits a screw pitch, which is determined in accordance with the optical characteristics of the right and left telescopic lens systems 12R and 12L, and the female screw, formed around the inner peripheral surface of the tubular shaft 54, exhibits a screw pitch, which is determined in accordance with the optical characteristics of the photographing lens system 67.

As shown in FIGS. 2, 3, and 7, a female-threaded bore 81 is formed in the bottom wall of the main casing section 10A, and is used to mount the binocular telescope with the digital camera on a tripod head. Namely, when the binocular telescope with the digital camera is mounted on the tripod head, the female-threaded bore 81 is threadedly engaged with a male screw of the tripod head. As is apparent from FIG. 2, when the movable casing section 10B is at the retracted position, the female-threaded bore 81 is positioned at a middle point of the retracted casing 10 and beneath the optical axis of the photographing lens system 67. Also, as is apparent from FIG. 7, the female-threaded bore 81 is contiguous with the front bottom edge of the main casing section 10A.

As shown in FIGS. 1, 2, and 3, an electric power source circuit board 82 is provided in the right end portion of the main casing section 10A, is attached to a frame structure 83 securely housed in the main casing section 10A. Also, as shown in FIGS. 2, 3, and 7, a main control circuit board 84 is provided in the main casing section 10A, and is arranged beneath the support-plate assembly 20. Although not illustrated, the main control circuit board 84 is suitably and securely supported by the bottom of the main casing section 10A. Various electronic elements, such as a microcomputer, memories and so on are mounted on the main control circuit board 84.

In this embodiment, as is apparent from FIGS. 2, 3, and 7, an LCD (Liquid Crystal Display) panel unit 86 is arranged on the top wall of the main casing section 10A, and is rotatably mounted on a pivot shaft 88 suitably supported by the top wall of the main casing section 10A and extending along the top front edge thereof. The LCD panel unit 86 is usually positioned at a retracted position shown by a solid line in FIG. 7, such that a display screen of the LCD panel unit 86 is directed to the top wall surface of the main casing section 10A. Thus, when the LCD unit 86 is positioned at the retracted position, it is impossible for a user or spectator to view the display screen of the LCD unit 86. When the LCD panel unit 86 is manually rotated from the retracted position to a display position as partially shown by a broken line in FIG. 7, it is possible for the user or spectator to view the display screen of the LCD panel unit 86.

As shown in FIGS. 1, 2 and 3, the left end portion of the movable casing section 10B is partitioned by the partition 29, thereby defining a battery chamber 90 for accommodating two batteries 92. The electric power source circuit board 82 is supplied with an electric power from the batteries 82 through a flexible electric power supply cord (not shown), and then the image-sensor control circuit board 72, the main control circuit board 84, the LCD panel unit 86 and so on are supplied with electric powers from the electric power source circuit board 82 through flexible electric power supply cords (not shown).

As best shown in FIGS. 2 and 3, two connector terminals 94 and 95 are mounted on the electric power source circuit board 82, and are accessible from outside through two access openings formed in the front wall of the main casing section 10A. Note, in FIG. 1, only one of the two access openings, which is provided for the connector terminal 95, is indicated by reference 95′. In this embodiment, the connector terminal 94 is used as a video connector terminal for connecting the digital camera to a domestic TV set, and the connector terminal 95 is used as a USB (Universal Serial Bus) connector terminal for connecting the digital camera to a personal computer. As shown in FIGS. 1, 2, and 3, the electric power source circuit board 82 is covered together the connector terminals 94 and 95 with an electromagnetic shielding 96 made of a suitable electric conductive material, such as copper, steel or the like.

As shown in FIGS. 2, 3, and 7, a suitable memory card driver, such as a CF (Compact Flash) card driver 97, is mounted on the underside of the main control circuit board 84, and is arranged in a space between the bottom wall of the main casing section 10B and the main control circuit board 84. A memory card or CF card is detachably loaded in the CF card driver 97.

According to the present invention, since a focal depth of the photographing lens system 67 is very shallow, it is necessary to automatically perform the focussing of the photographing lens system 67. Namely, the focussing mechanism for the photographing lens system 67 requires a high degree of focussing accuracy because of the shallow focal depth of the photographing lens system 67. Thus, it is impossible to manually focus the photographing lens system 67 because of the required high degree of focussing accuracy. In short, the focussing accuracy of the focussing mechanism for the photographing lens system 67 is too high to manually operate the focussing mechanism for the photographing lens system 67.

On the other hand, it is possible to manually operate the focussing mechanism for both the right and left telescopic lens systems 12R and 12L because the focussing accuracy required for focussing both the telescopic lens systems 12R and 12L is sufficiently lower than that for focussing the photographing lens system 67. In particular, the focussing accuracy of the focussing mechanism for both the right and left telescopic lens systems 12R and 12L depends on the self-focussing ability of a human's eyes. Namely, when an object is brought into focus through both the telescopic lens systems 12R and 12L with a degree of ±0.5 diopter, it is possible for a user or spectator to observe the object as a properly-focussed image due to the self-focussing ability of a human's eyes. Thus, the manual focussing of both the telescopic lens systems 12R and 12L is possible.

Accordingly, in this embodiment, when the binocular telescope with the digital camera is used as only a usual binocular telescope, the focussing of both the right and left telescopic lens systems 12R and 12L is performed by manually rotating the rotary wheel 56. However, as stated hereinafter, when a photograph can be taken by using the contained digital camera, the focussing mechanism for both the right and left telescopic lens systems 12R and 12L and the focussing mechanism for the photographing lens system 67 are automatically operated so as to perform the focussing of both the right and left telescopic lens systems 12R and 12L and the focussing of the photographing lens system 67 in an automatic focussing manner.

To automatically perform the focussing of both the right and left telescopic lens systems 12R and 12L and the focussing of the photographing lens system 67, a part of the rotary wheel 56 is formed as a gear wheel 98, as best shown in FIG. 7. On the other hand, an electric motor 100, such as a stepping motor, is securely mounted on the rectangular plate member 20A of the support-plate assembly 20, and an output shaft of the stepping motor 100 is coupled to a clutch 102, such as an electromagnetic (E/M) clutch. A gear wheel 104 is securely mounted on an output shaft of the E/M clutch 102, and is engaged with the gear wheel 98 of the rotary wheel 56.

While the binocular telescope with the digital camera is used as only a usual binocular telescope, the electromagnetic clutch 102 is turned OFF to thereby disengage the gear wheel 104 from the stepping motor 100, and thus it is possible to manually drive the rotary wheel 56 to operate the focussing mechanism for both the right and left telescopic lens systems 12R and 12L such that an object is brought into focus through both the telescopic lens systems 12R and 12L.

Note, during the manual driving of the rotary wheel 56, although the focussing mechanism for the photographing lens system 67 is operated, it is presupposed that a photographing operation cannot be performed.

On the other hand, a photograph can be taken by using the contained digital camera. To do this, the electromagnetic clutch 102 is turned ON to thereby engage the gear wheel 104 with the stepping motor 100. Thus, the rotary wheel 56 is automatically driven by the stepping motor 100, thereby operating the focussing mechanism for both the right and left telescopic lens systems 12R and 12L and the focussing mechanism for the photographing lens system 67 in the automatic focussing manner.

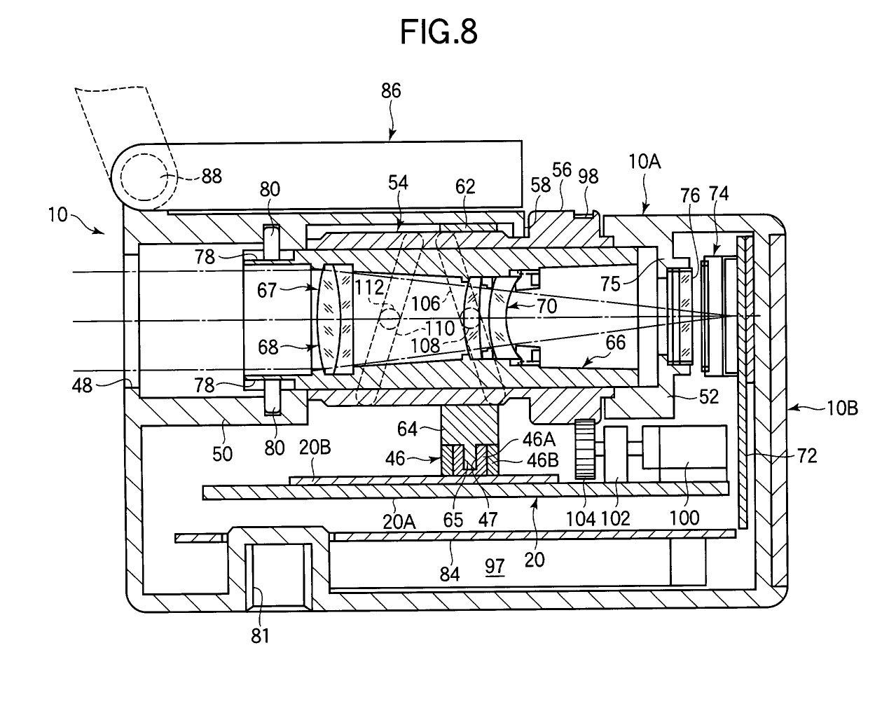

FIG. 8, similar to FIG. 7, shows a modification of the aforesaid embodiment of the binocular telescope containing the digital camera. Note, in FIG. 8, the features similar to those of FIG. 7 are indicated by the same references.

In the modified embodiment shown in FIG. 8, the focussing mechanism or movement-conversion mechanism for both the right and left telescopic lens systems 12R and 12L is formed by a cam groove 106 formed around the outer wall surface of the tubular shaft 54, and a stub-like cam follower 108, which protrudes from the inner wall surface of the annular member 62, and which is engaged in the cam groove 106. Note, in FIG. 8, the cam groove 106 is shown by a broken line as being developed and spread over a plane. Thus, similar to the aforesaid embodiment, the rotational movement of the rotary wheel 56 is converted into a translational movement of both the right optical system (16R, 18R) and the left optical system (16L, 18L).

Also, in the modified embodiment, the focussing mechanism or movement-conversion mechanism for the photographing lens system 67 is formed by a cam groove 110 formed around the innerwall surface of the tubular shaft 54, and a stub-like cam follower 112, which protrudes from the outer wall surface of the lens barrel 66, and which is engaged in the cam groove 110. Note, similar to the cam groove 106, the cam groove 110 is shown by a broken line as being developed and spread over a plane. Thus, similar to the aforesaid embodiment, the rotational movement of the rotary wheel 56 is converted into a translational movement of the lens barrel 66.

As is apparent from FIG. 8, the cam grooves 106 and 110 are reversely oriented with respect to each other. Accordingly, when both the erecting prism system (16R, 16L) and the ocular lens system (18R, 18L) are moved rearward away from the corresponding objective lens system (14R, 14L) by manually driving the rotary wheel 56, the lens barrel 66 is moved forward away from the CCD image sensor 74. Thus, similar to the aforesaid embodiment, when the rearward movement of both the erecting prism system (16R, 16L) and the ocular lens systems (18R, 18L) is performed so as to bring a near object into focus in the telescopic lens system (12R, 12L), it is possible to focus the observed near object on the light-receiving surface of the CCD image sensor 74 due to the forward movement of the lens barrel 66, and therefore, the photographing lens system 67.

In the aforesaid embodiment as shown in FIGS. 1 to 7, since the focusing mechanism or movement-conversion mechanism for both the right and left telescopic lens systems 12R and 12L is formed by the male and female screws, there is a linear relationship between the rotational movement of the rotary wheel 56 and the translational movement of both the right optical system (16R, 18R) and the left optical system (16L, 18L). Similarly, since the focussing mechanism or movement-conversion mechanism for the photographing lens system 67 is formed by the male and female screws, there is a linear relationship between the rotational movement of the rotary wheel 56 and the translational movement of the photographing lens system 67.

However, in reality, there is not necessarily a linear relationship between a focussed position of both the right optical system (16R, 18R) and the left optical system (16L, 18L) and a distance measured from the focussed position of both the right and left optical systems (16R; 18R, and 16L; 18L) to both the objective lens systems 14R and 14L. Similarly, there is not necessarily a linear relationship between a focussed position of the photographing lens system 67 and a distance measured from the focussed position of the photographing lens system 67 to the light receiving surface of the CCD image sensor 74.

Thus, before both the right and left optical systems (16R; 18R, and 16L; 18L) and the photographing lens system 67 can be precisely positioned at respective focussed positions, each of the movement-conversion mechanisms should be formed by the cam groove (106, 110) and the cam follower (108, 112) as shown in FIG. 8, because it is possible to nonlinearly move both the right and left optical systems (16R; 18R, and 16L; 18L) and the photographing lens system 67 in relation to both the objective lens system 14R and 14L and the CCD image sensor 74, respectively. In short, by using the cam grooves 106 and 110 and the cam followers 108 and 112, it is possible to precisely position both the right and left optical systems (16R; 18R, and 16L; 18L) and the photographing lens at the respective focussed positions.

Of course, since both the right and left telescopic lens systems 12R and 12L and the photographing lens system 67 have a certain amount of focal depth, there is no trouble in forming the corresponding movement-conversion mechanism by the male and female screws. However, as an object to be focussed gets nearer to the binocular telescope with the digital camera, it is more difficult to linearly approximate a relationship between the focussed position of the optical system (16R; 18R; 16L; 18L or 67) and the corresponding distance. For example, when both the right and left telescopic lens systems 12R and 12L and the photographing lens system 67 are designed such that the nearest object, that is situated less than 1.0 meter ahead of the binocular telescope with the digital camera, can be focussed, it is impossible to linearly approximate a relationship between the focussed position of the optical system (16R; 18R; 16L; 18L or 67) and the corresponding distance. In this case, it is necessary to form the focussing mechanisms or movement-conversion mechanisms by the respective cam groove 106 and 110 and the respective cam follower 108 and 112, as shown in FIG. 8.

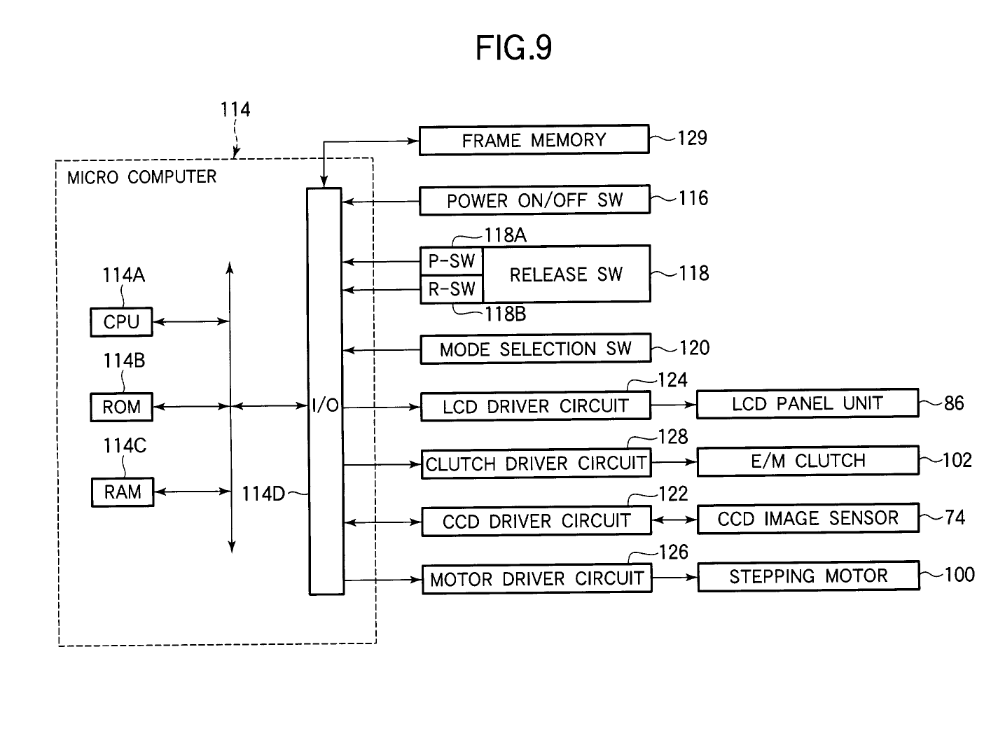

FIG. 9 shows a control block diagram for the binocular telescope with the digital camera, explained with reference to FIGS. 1 to 8. In FIG. 9, the microcomputer, mounted on the main control circuit board 84, is indicated by reference 114, and controls the binocular telescope with the digital camera as a whole. As illustrated, the microcomputer 114 comprises a central processing unit (CPU) 114A, a read-only memory (ROM) 114B for storing programs and constants, a random-access memory (RAM) 114C for storing temporary data, and an input/output interface circuit (I/O) 114D.

Although not shown in FIGS. 1 to 8, various switches are suitably arranged on the top wall of the main casing section 10A. In FIG. 9, a power ON/OFF switch 116, a release switch 118, and a mode selection switch 120 are shown as switches, which especially relate to the present invention.

The power ON/OFF switch 116 may be formed as a slide switch which is movable between an OFF-state position and an ON-state position. When the power ON/OFF switch 116 is at the OFF-state position, the microcomputer 114 is put at a sleep-mode state or minimum power-consumption state, in which it is monitored by the microcomputer 114 whether only the power ON/OFF switch 116 has been operated. Namely, all operations of the other switches except for the power ON/OFF switch are disabled at the sleep-mode state.

When the power ON/OFF switch 116 is moved from the OFF-state position to the ON-state position, it is monitored by the microcomputer 114 whether each of the various switches has been operated.

The release switch 118 may be formed as a self-return type depression switch, and comprises two switch elements 118A and 118B associated with each other. The switch element 118A serves as a photometry switch element (P-SW), and the switch element 118B serves as a release switch element (R-SW). When the release switch 18 is half depressed, the photometry switch element (P-SW) 118A is turned ON, whereby a photometry measurement is executed by the microcomputer 114. Also, when the release 118 is fully depressed, the release switch element (R-SW) 118B is turned ON, whereby a photographing operation is performed by the microcomputer 114.

The mode selection switch 120 may be formed as a digital rotary switch for selecting any one of various modes, such as a display mode, a reproduction mode, and so on. An object to be photographed is displayed as a motion picture on the LED panel unit 86 when selecting the display mode is selected, and a photographed image is displayed as a still picture on the LCD panel unit 86 when selecting the reproduction mode, as stated in detail hereinafter.

In FIG. 9, reference 122 indicates a CCD driver circuit for driving the CCD image sensor 74, and the CCD driver circuit 122 is operated under control of the microcomputer 114. Reference 124 indicates an LCD driver circuit for driving the LCD panel unit 86, and the LCD driver circuit 124 is operated under control of the microcomputer 114. Reference 126 indicates a motor driver circuit for outputting a series of drive pulses to thereby drive the stepping motor 100, and the motor driver circuit 126 is operated under control of the microcomputer 114. Reference 128 indicates an clutch driver circuit for driving the E/M clutch 102, and the clutch driver circuit 128 is operated under control of the microcomputer 114. Reference 129 indicates a frame memory provided on the main control circuit board 84.

While the power ON/OFF switch 116 is at the OFF-state position, the electromagnetic clutch 102 is turned OFF, and thus it is possible to operate the focussing mechanism for both the right and left telescopic lens systems 12R and 12L by manually driving the rotary wheel 56, as already stated above. When the power ON/OFF switch 116 is moved from the OFF-state position to the ON-state position, the electromagnetic clutch 102 is turned ON, thereby making it impossible that the rotary wheel 56 is manually driven.

During the ON-state of the electromagnetic clutch 102, when the release switch 118 is half depressed to thereby turn ON the photometry switch element 118A, the stepping motor 100 is driven such that the focussing mechanism for both the right and left telescopic lens systems 12R and 12L and the focussing mechanism for the photographing lens system 67 are operated in the automatic focussing (AF) mode, as stated in detail hereinafter. Note, of course, during the ON-state of the photometry switch element 118A, the photometry measurement is executed by the microcomputer 114.

As stated above, an object to be photographed is formed as an optical image on the light-receiving surface of the CCD image sensor 74 through the photographing lens system 67 and the optical low-pass filter 76. While the power ON/OFF switch 116 is at the ON-state position, the optical image is converted into a frame of analog image-pixel signals by the CCD image sensor 74. While the display mode is selected by operating the mode selection switch mode 120, a frame of thinned analog image-pixel signals is successively read from the CCD image sensor 74 at suitable time intervals, and the thinned analog image-pixel signals in each frame are suitably processed and converted into a frame of digital image-pixel signals. The frame of digital image-pixel signals is successively stored in the frame memory 129 on the main control circuit board 84, and is read as a digital video signal from the frame memory 129. The digital video signal is converted into an analog video signal, and the object image is reproduced as a motion picture on the LCD panel unit 86 based on the video signal. Namely, it is possible for a user to monitor the object to be photographed on the LCD panel unit 86.

When the release switch 118 is fully depressed to thereby turn ON the release switch element 118B, a frame of full analog still image-pixel signals is read from the CCD image sensor 74 without being thinned, and is suitably processed and converted into a frame of full digital still image-pixel signals. Then, the frame of full digital still image-pixel signals is stored in the frame memory 129 on the main control circuit board 84, and is subjected to suitable image processings. Thereafter, the processed digital still image-pixel signals for one frame are stored in the CF memory card, loaded in the CF memory card driver 97, in accordance with a given format.

When the reproduction mode is selected by operating the mode selection switch 120, the digital still image-pixel signals in each frame are thinned and read from the CF memory card, loaded in the CF memory card driver 97, and are processed to thereby produce a video signal. Then, the photographed image is reproduced as a still image on the LCD panel unit 86, based on the video signal. Optionally, it is possible to feed the video signal to a domestic TV set through the video connector terminal 94, to reproduce the photographed image on a domestic TV set.

Also, the digital still image-pixel signals in each frame may be fed from the CF memory card to a personal computer with a printer through the UBS connector terminal 95, to thereby print the photographed image as a hard copy by using the printer. Of course, when the personal computer is provided with a CF memory card driver, the CF memory card, unloaded from the CF memory card driver 97, may be loaded in the CF memory card driver of the personal computer.

Before the focussing of the photographing lens system 67 can be suitably and properly performed in the automatic focussing (AF) manner, the binocular telescope with the digital camera must be constituted so as to fulfill predetermined conditions, as discussed in detail below.

In the embodiment shown in FIGS. 1 to 7 and the modified embodiment shown in FIG. 8, the photographing lens system 67 is optically designed such that an object, which is situated 1.0 meter ahead of the digital camera, can be brought into focus in the automatic focussing (AF) manner, as already stated above. Under these conditions, before a desirable focussing accuracy can be obtained, it is necessary to properly and optimally determine the yield depth of the photographing lens system 67, which is defined by a focal length “f” of the photographing lens system 67, a f-number F of the photographing lens system 67, a diameter δ of the permissible circle of confusion of the CCD image sensor 74, and so on.

As discussed hereinbefore, in a camera using a 35 mm silver halide film, the diameter δ of the permissible circle of confusion is defined as an approximately 1/1000 of a diagonal line length of the film frame. However, in a digital camera using the CCD image sensor 74, the diameter δ of the permissible circle of confusion is defined as follows:

δ=aP

Herein:

“P” is a pixel pitch of the CCD image sensor 74; and

“a” is a suitable constant.

When the diameter δ of the permissible circle of confusion is simply defined as the pixel pitch of the CCD image sensor 74, of course, a setting of “1” is given to the constant “a”. In this embodiment, since the optical low-pass filter 76 is incorporated in the CCD image sensor 74, the constant “a” may be selected from a range between approximately “1.4” and approximately “3.0”.

In particular, when the optical low-pass filter 76 is not incorporated in the CCD image sensor 74, and when an object to be photographed exhibits a spatial frequency coinciding with the pixel pitch of the CCD image sensor 74, moire fringes are produced on a reproduced image at the area exhibiting the spatial frequency concerned. In short, a high spatial frequency component, which is nearly equal to the pixel pitch of the CCD image sensor, is removed from the light beam captured by the photographing lens system 67, due to the existence of the optical low-pass filter 76, thereby preventing the production of the moire fringes. Thus, it is possible to give the setting of more than “1” to the constant “a” (from approximately “1.4” and approximately “3.0”).

In short, when the respective focal depth and field depth of the photographing lens system 67 are represented by reference “Dᵢ” and “Dₒ”, the focal depth “Dᵢ” and the field depth “Dₒ” are defined as follows:

Dᵢ=aPF

Dₒ=f²/Dᵢ=f²/aPF

On the other hand, the focal length “f” of the photographing lens system 67 is defined as follows:

f=y/ tan(ω/T)

Herein:

“y” represents a maximum image height (mm) of the CCD image sensor 74, which is defined as one-half of a diagonal line length of the light-receiving surface of the CCD image sensor 74;

“ω” represents a half field angle (rad) of the right and left telescopic lens systems 12R and 12L; and

“T” represents a field ratio of the half field angle “ω” to a half field angle “θ” (rad) of the photographing lens system 67 (T=ω/θ).

Accordingly, the field depth “Dₒ” of the photographing lens system 67 may be represented as follows:

Dₒ=y²/[tan²(ω/T)×aPF]

Since the right and left telescopic lens systems 12R and 12L are provided for magnifying and observing a far object, a real field angle of the telescopic lens systems 12R and 12L is very narrow. Namely, “ω/T” is very small, and thus it is possible to regard the parameter “tan (ω/T)” as “ω/T” (tan (ω/T)≈ω/T) . Also, the constant “a” is suitably selected from the aforesaid range (from approximately “1.4” to approximately “3.0”) in accordance with how a frame of digital still image-pixel signals is processed. For example, a value of the constant “a”, selected when the digital still image-pixel signals in a frame are processed to be reproduced on either the LCD panel unit 86 or the domestic TV set, is different from a value of the constant “a” selected when the digital still image-pixel signals in a frame are processed to print an image as a hard copy by using a printer associated with a personal computer. Thus, the constant “a” may be omitted from the aforesaid equation.

In short, the aforesaid equation, representing the field depth “Dₒ” of the photographing lens system 67, may be modified as follows:

Dₒ∝y²/[(ω/T)²×PF]

Of course, this equation forms a criterion representing the field depth of the photographing lens system 67 when an object in infinity is brought into focus. In general, since a distance, measured from the photographing lens system 67 to an object to be photographed, is expressed in meters, the equation is divided by “1000” as follows:

Dₒ/1000∝y²/[1000×PF(ω/T)²]

Thus, before the focusing mechanism for the photographing lens system 76 can be suitably and properly operated in the automatic focussing manner, it is necessary to select values of the parameters “y”, “ω”, “P”, “T”, and “F” so as to fulfil the following conditional equation:

y²/[1000×PF(ω/T)²]>80

The larger the value of “y²/[1000×PF(ω/T)²]”, the narrower the focal depth of the photographing lens system 67. When the value of “y²/[1000×PF(ω/T)²]” has more than the critical value “80”, it is difficult to manually operate the focussing mechanism for the photographing lens system 67, and thus the focussing mechanism for the photographing lens system 67 must be operated in the automatic focussing manner. The critical value “80” is empirically obtained from the accumulation of knowledge on past designs of photographing lens systems, and is well known in the design field of the photographing lens systems. Although the critical value “80” is somewhat variable, it forms a criterion whether the focussing mechanism for the photographing lens system 67 should be operated in the manual focussing manner or the automatic focussing manner.

When values of the parameters “y”, “ω”, “P”, “T”, and “F” are selected such that “y²/[1000×PF(ω/T)²]” has more than the critical value “80”, various matters should be taken into consideration as stated below.

First, the pixel pitch “P” is variable in accordance with the type of the CCD image sensor 74 being used, and this influences the sensitivity of the CCD image sensor 74 and the f-number “F” of the photographing lens system 67. Namely, in order to make the sensitivity of the CCD image sensor 74 higher, it is necessary to make the pixel pitch “P” of the CCD image sensor 74 larger, i.e. to decrease a number of pixels of the CCD image sensor 74 or it is necessary to make the maximum image height “y” of the CCD image sensor 74 larger.

When the number of pixels of the CCD image sensor 74 is decreased, under the condition where the maximum image height “y” of the CCD image sensor 74 is constant, the quality of a photographed image is deteriorated. On the other hand, when the number of pixels of the CCD image sensor 74 is increased, under the condition where the maximum image height “y” of the CCD image sensor 74 is constant, the pixel area corresponding to each pixel is made smaller, and this results in the lowering of the sensitivity of the CCD image sensor 74.

In order to raise the sensitivity of the CCD image sensor 74, the maximum image height “y” of the CCD image sensor 74 must be increased. The increase of the maximum image height “y” results in a large-scale CCD image sensor (74). In this case, if the field angle of the photographing lens system 67 is maintained at a constant, the focal length “f” of the photographing lens system 67 becomes considerably longer, resulting in the need for a very large-scale photographing lens system (67). Also, in general, the sensitivity of a CCD image sensor is lower than that of a silver halide film.

Taking the above-discussed conditions into consideration, it is necessary to give a setting of less than “6” to the f-number F of the photographing lens system 67 (F<6).

To give a setting of less than the critical value “80” to “y²/[1000×PF(ω/T)²]” means that “y/(ω/T)” is made smaller, that the pixel pitch “P” is made larger, or that the f-number “F” is made larger. To make “y/(ω/T)” smaller means that the maximum image height “y” is smaller or that the field ratio “T” is made smaller. As already discussed, when the maximum image height “y” is made smaller without decreasing the number of pixels of the CCD image sensor 74, the sensitivity of the CCD image sensor 74 is lowered. When the pixel pitch of the CCD image sensor 74 is increased, i.e. when the number of pixels of the CCD image sensor 74 is decreased, to maintain the sensitivity of the CCD image sensor 74, the quality of a photographed image is deteriorated. On the other hand, when the field ratio “T” is made too large, the photographing area of the photographing lens system 67 becomes larger than a view area of both the right and left telescopic lens systems 12R and 12L, and thus the right and left telescopic lens systems 12R and 12L cannot be utilized as an optical view finder lens system for the photographing lens system 67. Also, the increase of the pixel pitch “P” and the f-number “F” has the undesirable effects, as already discussed.

In all cases, taking the above-discussed matters into consideration, the values of the parameters “y”, “ω”, “P”, “T”, and “F” must be selected such that aforesaid conditional equation is satisfied before the focusing mechanism for the photographing lens system 67 can be suitably and properly operated in the automatic focussing manner.

For example, when a ⅓ inch CCD image sensor (74) is utilized, the parameters “y”, “ω”, “P”, “T”, and “F” may be selected as follows:

y=2.98 mm

ω=0.06231 rad (3.57°)

P=0.0047 mm (4.7 μm)

T=0.78

F=2.8

In this case, the value of “y²/[1000×PF(ω/T)²]” is “106”.

Also, when a 1/2.7 inch CCD image sensor (74) is utilized, the parameters “y”, “ω”, “P”, “T”, and “F” may be selected as follows:

y=3.32 mm

ω=0.06231 rad (3.57°)

P=0.0042 mm (4.2 μm)

T=0.70

F=2.8

In this case, the value of “y²/[1000×PF(ω/T)²]” is “118”.

In short, before the focusing of the photographing lens system 67 can be suitably and properly performed in the automatic focussing manner, the binocular telescope with the digital camera according to the first embodiment must be constituted such that the following conditions are fulfilled:

y²/[1000×PF(ω/T)²]>80 and F<6

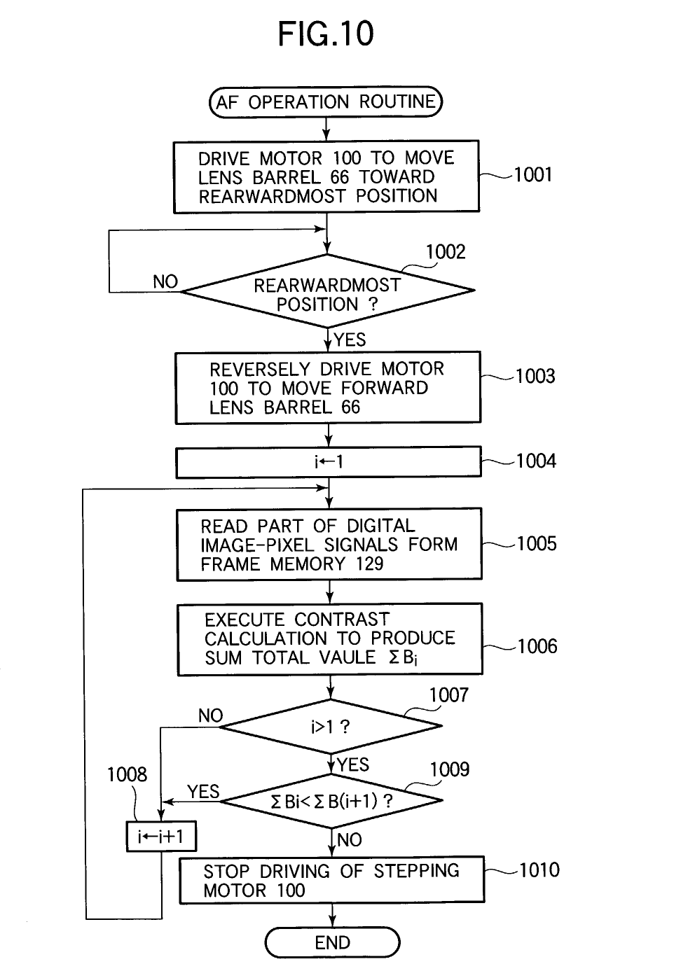

FIG. 10 shows a flowchart of an automatic focussing (AF) operation routine executed in the microcomputer 114. The AF operation routine is executed when the photometry switch element 118A is turned ON by half depressing the release switch 118, and the execution of the AF operation routine is continued as long as the photometry switch element 118A is at the ON-state. Note, the AF operation routine is based on a so-called contrast method.

In step 1001, the stepping motor 100 is driven such that the lens barrel 66 is moved toward the rearwardmost position where it is closest to the CCD image sensor 74. Of course, at this time, both the right and left optical systems (16R; 18R, and 16L; 18L) are moved toward the forwardmost position where they are closest to both the objective lens systems 14R and 14L.

In step 1002, it is monitored whether the lens barrel 66 has reached the rearwardmost position. When the arrival of the lens barrel 66 at the rearwardmost position is confirmed, the control proceeds to step 1003, the stepping motor 100 is reversely driven such that the lens barrel 66 is moved forward from the rearwardmost position. Then, in step 1004, a setting of “1” is given to a variable “i”.

In step 1005, part of the digital image-pixel signals, corresponding to a predetermined area of one frame, are read from the frame memory 129, in which the digital pixel signals for one frame are successively renewed in accordance with a successive reading of a frame of analog image-pixel signals from the CCD image sensor 74. Then, in step 1006, a contrast calculation is executed based on the digital image-pixel signals read from the frame memory 129. Namely, in the contrast calculation, a difference Bᵢ between brightness levels of two consecutive digital image-pixel signals is successively calculated, and all the calculated differences Bᵢ are totaled to thereby produce the total value ΣBᵢ.

In step 1007, it is determined whether a value of the variable “i” is more than “1”. At this initial stage, since i=1 (i.e. the contrast calculation is only once executed), the control proceeds to step 1008, in which the value of the variable “i” is incremented by “1”. Thereafter, the control returns to step 1005. Namely, the contrast calculation is again executed based on part of the digital image-pixel signals subsequently read from the frame memory 129, thereby producing the total value ΣBᵢ (steps 1005 and 1006).

At this stage, since i=2, the control proceeds from step 1007 to 1009, in which it is determined whether the last total value ΣB₍ᵢ₋₁₎ is smaller than the present total value ΣBᵢ. If ΣB₍ᵢ₋₁₎<ΣBᵢ, the control proceeds to step 1008, in which the value of the variable “i” is incremented by “1”. Thereafter, the control returns to step 1005. Namely, the contrast calculation is further executed based on a part of digital image-pixel signals subsequently read from the frame memory 129, thereby producing the total value ΣBᵢ (steps 1005 and 1006), and the penultimate total value ΣB₍₁₋₁₎ is compared to the last calculated total value ΣBᵢ (step 1009). As long as the penultimate total value ΣB₍ᵢ₋₁₎ is smaller than the last calculated total value ΣBᵢ, the contrast calculation is repeatedly executed.

In step 1009, when the penultimate total value ΣB₍ᵢ₋₁₎ becomes larger than the last calculated total value ΣBᵢ, it is regarded that the difference Bᵢ (contrast) between the brightness levels of the two consecutive digital image-pixel signals is at a maximum, i.e. that the optical image is most sharply focussed through the photographing lens system 67 on the light-receiving surface of the CCD image sensor 74. At this point, the control proceeds from step 1009 to step 1010, in which the driving of the stepping motor 100 is stopped, and thus the automatic focussing of both the telescopic lens systems 12R and 12L and the photographing lens system 67 is completed.

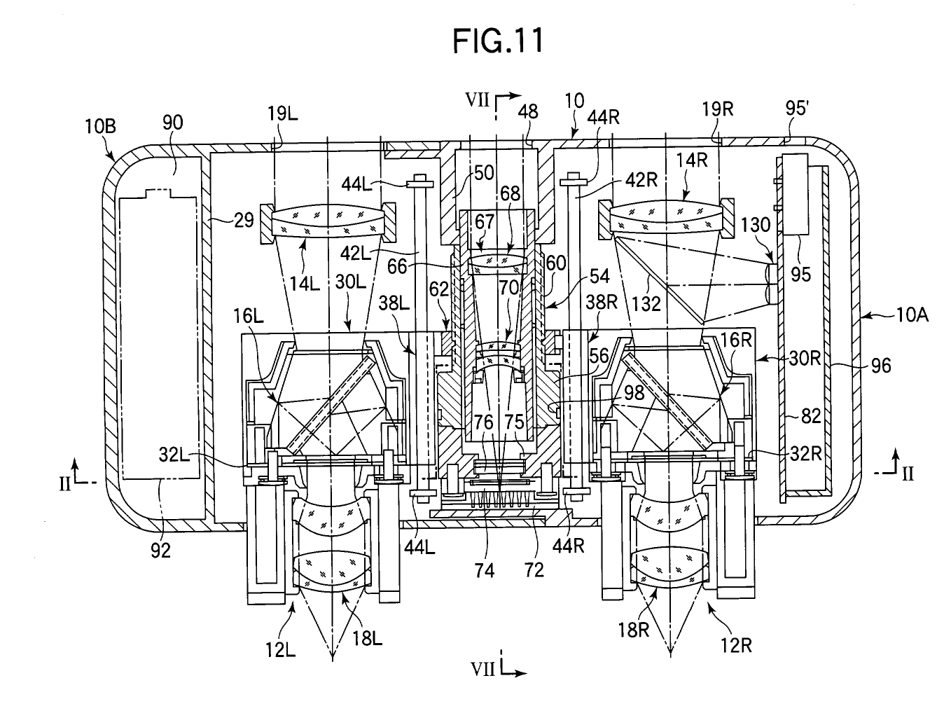

FIG. 11 shows a second embodiment of an optical viewer instrument with a photographing function according to the present invention, which is also constituted as a binocular telescope with a digital camera. FIG. 11 is a cross-sectional plan view similar to FIG. 1, and the second embodiment is formed in substantially the same manner as in the first embodiment. Note, in FIG. 11, the features similar to those of FIG. 1 are indicated by the same references.

In the second embodiment, the contrast method is not used to perform the automatic focussing of both the telescopic lens systems 12R and 12L and the photographing lens system 67. Instead, a distance measurement detector 130 is mounted on the electric power source circuit board 82, and is associated with a half mirror 132 incorporated in the right telescopic lens system 12R.

The distance measurement detector 130 is formed of a line image sensor, and a pair of semispherical lenses disposed on the line image sensor to be adjacent to each other. The half mirror 132 is supported by the frame structure 83 (FIGS. 2 and 3), and is arranged between the objective lens system 14R and the erecting prism system 16R to define an angle of 45° with respect to the optical axis of the telescopic lens system 12R. While a light beam carrying an object image is made incident on the objective lens system 14R, a part of the light beam is reflected by the half mirror 132 so as to be directed to the distance measurement detector 130, and the remaining part of the light beam passes through the half mirror 132 toward the erecting prism system 16R.

As shown in FIG. 11, a half part of the reflected light beam, passing through a half area of the objective lens system 12R is made incident on one of the semispherical lenses, and the remaining half part of the reflected light beam, passing through the other half area of the objective lens system 12R is made incident on the other semispherical lens, whereby the two object images are formed on the line image sensor through the pair of semispherical lenses. The distance between the two object images formed on the line image sensor varies in accordance with the object distance which is measured from the binocular telescope with the digital camera to the object corresponding to the object images formed on the line image sensor.

Note, although the half mirror is shown as being an obstacle to the movement of the optical system (16R and 18R) in FIG. 11, this is only due to the fact that FIG. 1 was utilized for the preparation of FIG. 11. Thus, in reality, the casing 10 should be somewhat enlarged such that the movement of the optical system (16R and 18R) can be allowed.

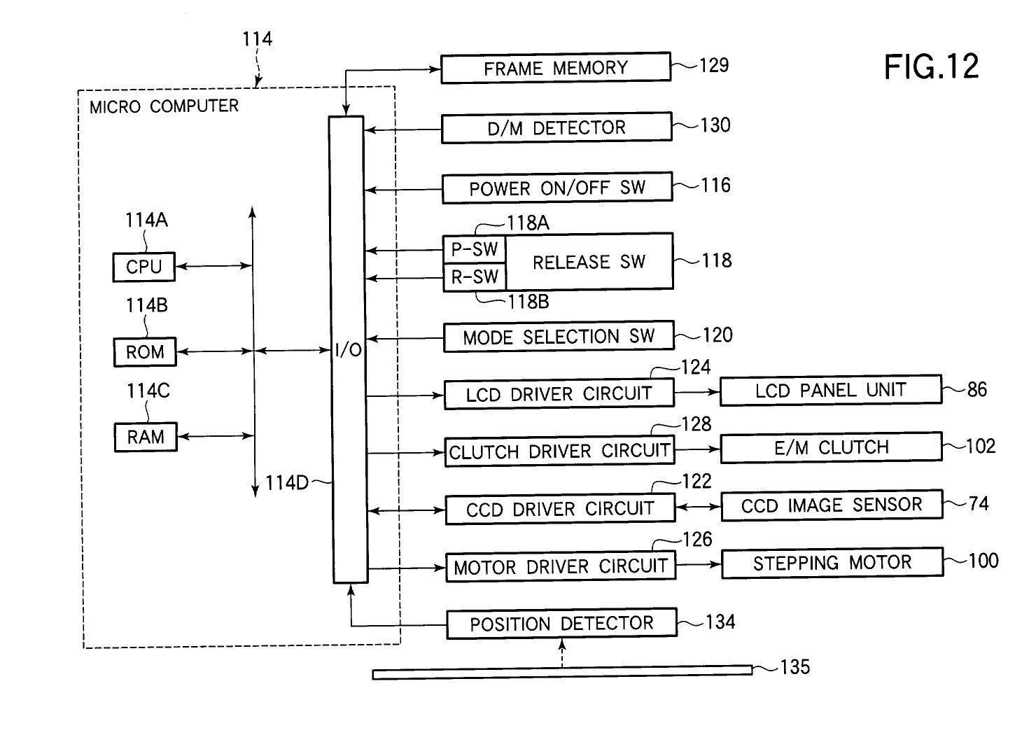

FIG. 12 shows a control block diagram for the second embodiment of the binocular telescope with the digital camera, which is substantially identical to the control block diagram, as shown in FIG. 9, except that the former block diagram features the distance measurement detector 130, a position detector 134 carried by the lens barrel 66, and a linear scale 135 associated with the position detector 134 and provided along a path for the movement of the lens barrel 66.

In the second embodiment, a relationship between an image distance to be detected by the distance measurement detector 130 and an object distance corresponding to that image distance is previously calibrated, and the calibrated data are stored as a two-dimensional image-distance/object-distance map in the ROM 114. Thus, when an image distance is detected by the distance measurement detector 130, it is possible for the microcomputer 114 to find a corresponding object distance by referring to the two-dimensional image-distance/object-distance map for the detected image distance.

The position detector 134 electronically reads divisions of the linear scale 135 to thereby detect a position of the lens barrel 66, and a focussed position of the photographing lens system 67 is represented by a division of the linear scale 135 read by the position detector 134. In FIG. 12, the reading of divisions of the linear scale 135 is symbolically represented by an arrow-headed broken line. A relationship between a focussed position of the photographing lens system 67 and an object distance obtained by the distance measurement detector 130 is previously calibrated, and the calibrated data are stored as a two-dimensional object-distance/focussing-position map in the ROM 114. Thus, when an object distance is obtained based on an image distance detected by the distance measurement detector 130, the corresponding focussed position of the photographing lens system 67 can be found by referring to the two-dimensional object-distance/focussing-position position map for the obtained object distance.

Similar to the aforesaid first embodiment, while the power ON/OFF switch 116 is at the OFF-state position, the electromagnetic clutch 102 is turned OFF, and thus it is possible to operate the focussing mechanism for both the right and left telescopic lens systems 12R and 12L by manually driving the rotary wheel 56, as already stated above. When the power ON/OFF switch 116 is at the ON-state position, the electromagnetic clutch 102 is turned ON, thereby making it impossible for the rotary wheel 56 to be manually driven.

Thus, in the second embodiment, during the ON-state of the electromagnetic clutch 102, the focussing mechanism for both the right and left telescopic lens systems 12R and 12L and the focussing mechanism for the photographing lens system 67 are also operated by the stepping motor 100 in the automatic focussing (AF) mode by half depressing the release switch 118.

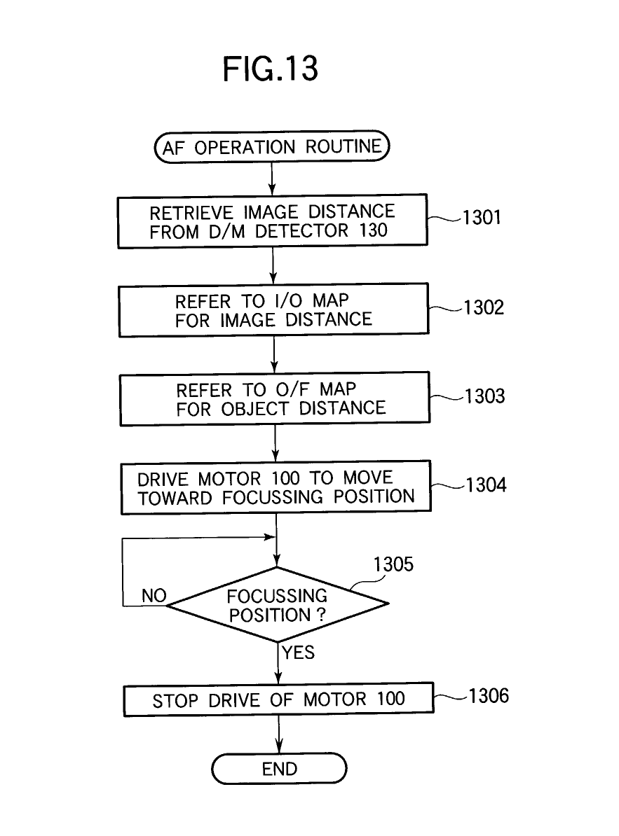

FIG. 13 shows a flowchart of an automatic focussing (AF) operation routine executed in the microcomputer 114 shown in FIG. 12. The AF operation routine is executed when the photometry switch element 118A is turned ON by half depressing the release switch 118, and the execution of the AF operation routine is continued as long as the photometry switch element 118A is in the ON-state.

In step 1301, an image distance is retrieved from the distance measurement detector 130. Then, in step 1302, the image-distance/object-distance map is referred to for the detected image distance to find a corresponding object distance, and, in step 1303, the object-distance/focussing-position map is referred to for the found object distance to find a corresponding focussed position of the photographing lens system 67, and therefor, a corresponding division on the linear scale 135.

In step 1304, the stepping motor 100 is driven such that the lens barrel 66, and therefore, the photographing lens system 67 is moved toward the corresponding focussed position. Then, in step 1305, it is monitored whether the lens barrel 66 has reached the focussed position. When the arrival of the lens barrel 66 at the focussed position is confirmed, the control proceeds to step 1306, in which the driving of the stepping motor 100 is stopped, and thus the automatic focussing of both the telescopic lens systems 12R and 12L and the photographing lens system 67 is completed.

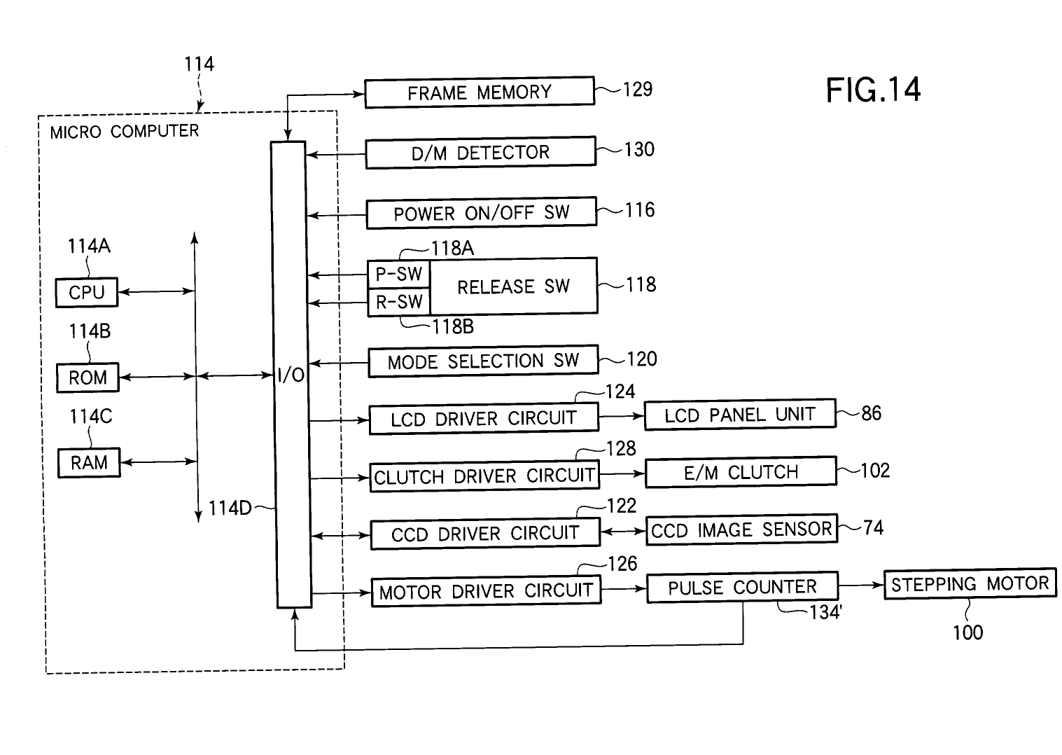

FIG. 14, similar to FIG. 12, shows a first modification of the second embodiment of the binocular telescope containing the digital camera. Note, in FIG. 14, the features similar to those of FIG. 12 are indicated by the same references.

In the first modification of the second embodiment, a pulse counter 134′ is substituted for the position detector 134, to thereby detect the number of drive pulses output from the motor driver circuit 126 to the stepping motor 100. Whenever the automatic focussing of both the telescopic lens systems 12R and 12L and the photographing lens system 67 is performed, first of all, the lens barrel 66 is moved to the rearwardmost position where it is closest to the CCD image sensor 74, and is then moved forward from the rearwardmost position. During the forward movement of the lens barrel 66, the number of drive pulses output from the motor driver circuit 126 is counted by the pulse counter 134′, and the counted pulse number represents the movement distance of the lens barrel 66. Thus, a focussed position of the photographing lens system 67 is represented by the number of drive pulses output from the pulse counter 134′.

A relationship between a focussed position of the photographing lens system 67 and an object distance obtained from the distance measurement detector 130 is previously calibrated, and the calibrated data are stored as a two-dimensional object-distance/focussing-position map in the ROM 114. Thus, when an object distance is obtained based on an image distance detected by the distance measurement detector 130, it is possible to find the corresponding focussed position by referring to the two-dimensional object-distance/focussing-position map for the obtained object distance.

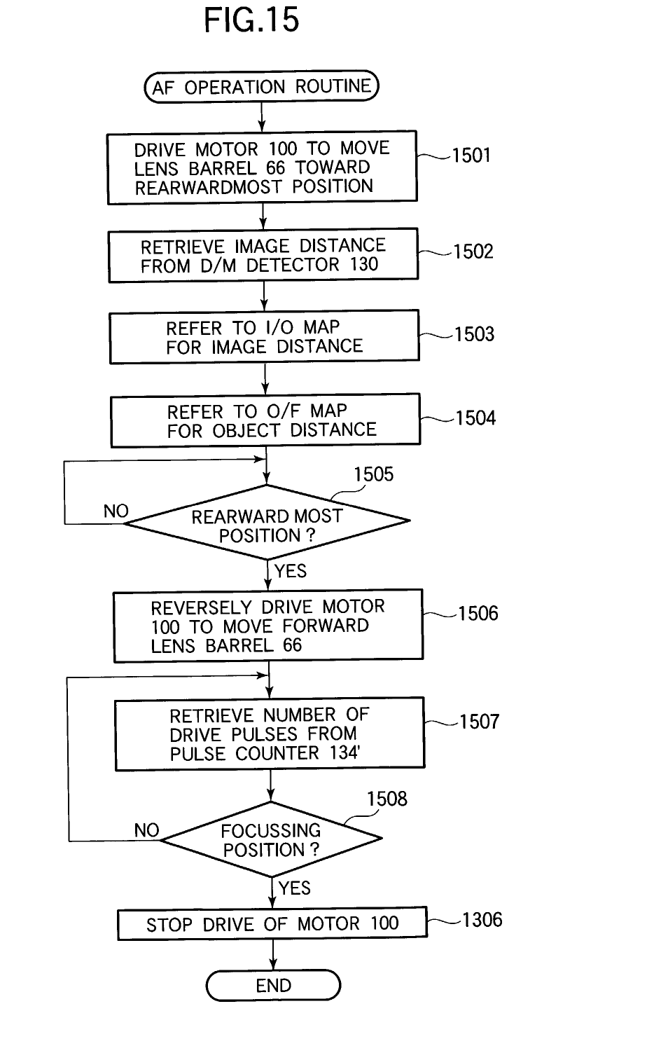

FIG. 15 shows a flowchart of an automatic focussing (AF) operation routine executed in the microcomputer 114 shown in FIG. 14. Similar to the case of the aforesaid second embodiment, the AF operation routine is executed when the photometry switch element 118A is turned ON by half depressing the release switch 118, and the execution of the AF operation routine is continued as long as the photometry switch element 118A is at the ON-state.

In step 1501, the stepping motor 100 is driven such that the lens barrel 66 is moved toward the rearwardmost position where it is closest to the CCD image sensor 74. Of course, at this time, both the right and left optical systems (16R; 18R, and 16L; 18L) are moved toward the forwardmost position where they are closest to both the objective lens systems 14R and 14L.

In step 1502, an image distance is retrieved from the distance measurement detector 130. Then, in step 1503, the image-distance/object-distance map is referred to for the detected image distance to find a corresponding object distance, and, in 1504, the object-distance/focussing-position map is referred to for the found object distance to find a corresponding focussed position of the photographing lens system, which is represented by the number of drive pulses output from the pulse counter 134′.

In step 1505, it is monitored whether the lens barrel 66 has reached the rearwardmost position. When the arrival of the lens barrel 66 at the rearwardmost position is confirmed, the control proceeds to step 1506, in which the stepping motor 100 is reversely driven such that the lens barrel 66 is move forward from the rearwardmost position.

In step 1507, the number of drive pulses, output from the motor driver circuit 126 to the stepping motor 100, is retrieved from the pulse counter 134′. Then, in step 1508, it is determined whether a movement distance of the lens barrel 66 coincides with a distance represented by the retrieved number of drive pulses, i.e. whether the photographing lens system 67 has reached the focussed position concerned. If the photographing lens system 67 has not reached the focussed position, the control returns to step 1507, and the routine comprising steps 1507 and 1508 is repeated until the photographing lens system 67 has reached the focussed position.

When the arrival of the photographing lens system 67 at the focussed position is confirmed, the control proceeds from step 1508 to step 1509, in which the driving of the stepping motor 100 is stopped, and thus the automatic focussing of both the telescopic lens systems 12R and 12L and the photographing lens system 67 is completed.

In the first modification of the second embodiment shown in FIG. 14, a counter program, previously stored in the ROM 114B, may be substituted for the pulse counter 134′. Of course, in this case, the drive pulses may be directly input from the motor driver circuit 126 to the I/O 114D of the microcomputer 114.

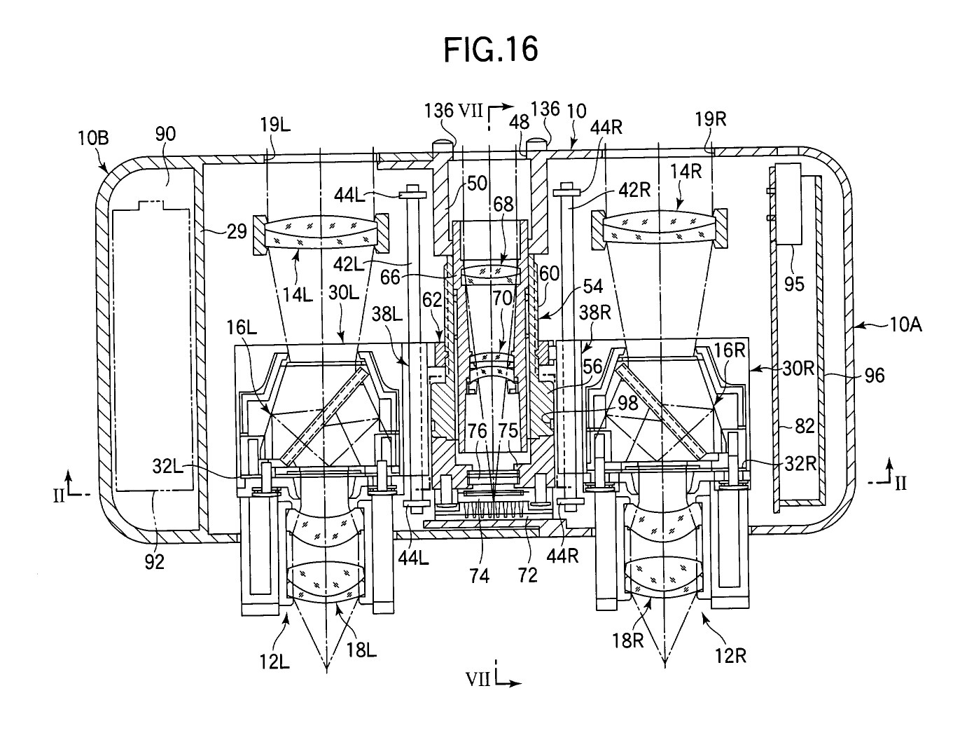

FIG. 16, similar to FIG. 1, shows a second modification of the second embodiment of the binocular telescope containing the digital camera. Note, in FIG. 16, the features similar to those of FIG. 1 are indicated by the same references.

In the second modification of the second embodiment, a distance measurement detector, comprising a pair of detecting elements 136, is substituted for the combination of the distance measurement detector 130 and the half mirror 132. The detecting elements 136 are securely attached to the front wall of the main casing section 10A so as to be diametrically and horizontally arranged with respect to the circular window 48 formed in the front wall of the main casing section 10A, as shown in FIG. 16.

Each of the detecting elements 136 is formed of a line image sensor, and a semispherical lens disposed on the line image sensor. An object to be captured by the photographing lens system 67 is focussed as an object image on the line image sensor of each detecting element 136 through the corresponding semispherical lens, and a position where the object image is focussed on the line image sensor varies in accordance with an object distance which is measured from the binocular telescope with the digital camera to the object. Thus, it is possible to measure the object distance based on an image distance between the object images formed on the line image sensors of the detecting elements 136, in substantially the same manner as in the distance measurement detector 130 shown in FIG. 11.

As is apparent from FIG. 16, according to the second modification of the second embodiment, since a distance between the detecting elements 136 can be made considerably larger than that between the semispherical lenses of the distance measurement detector 130 shown in FIG. 11, it is possible to more accurately measure an object distance with the distance measurement detector comprising the pair of detecting elements 136.

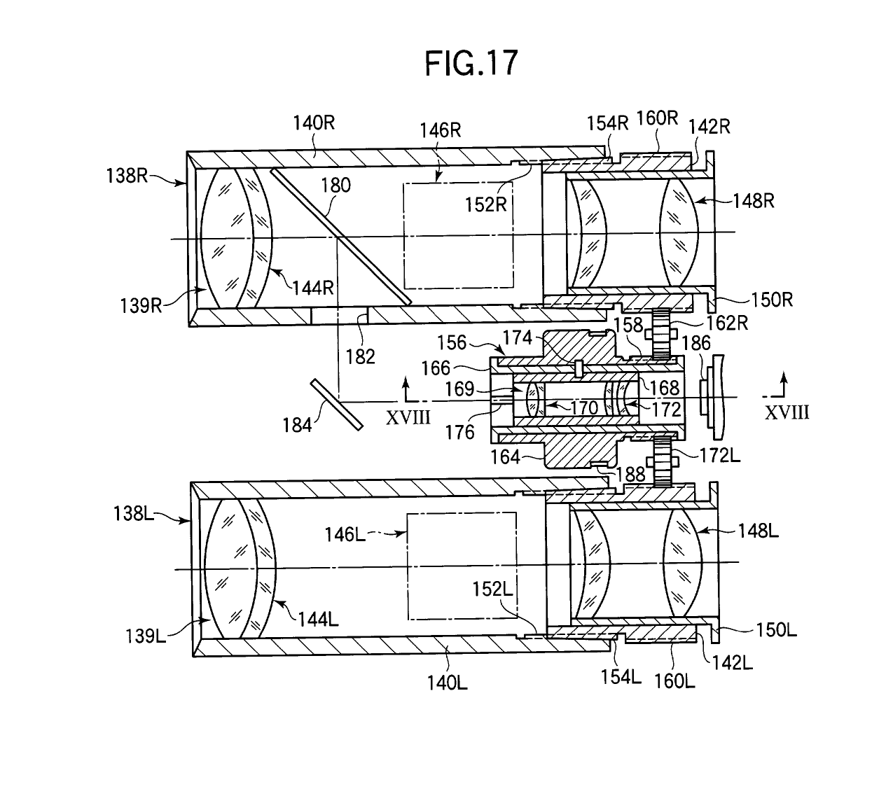

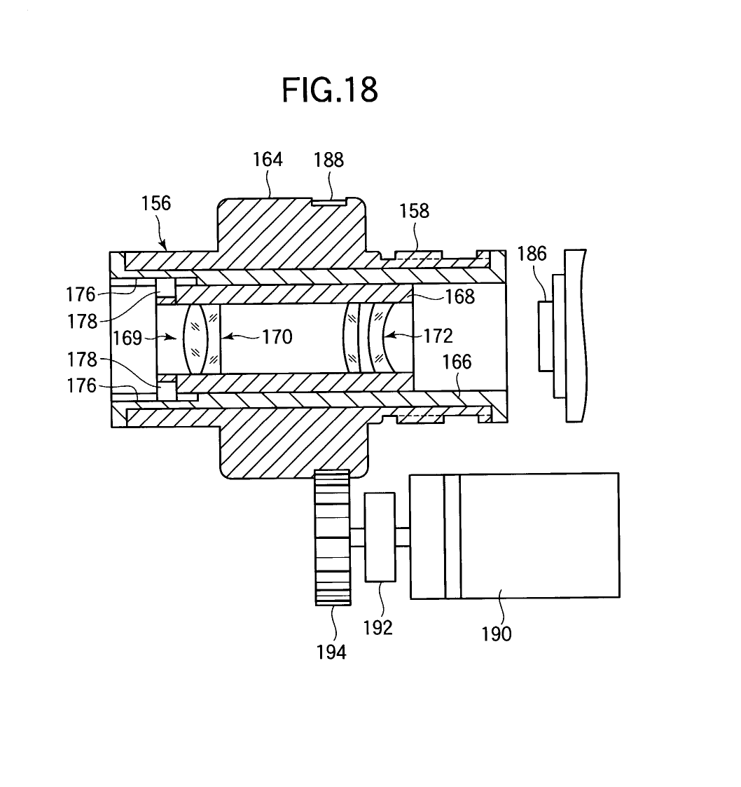

FIGS. 17 and 18 show a third embodiment of an optical viewer instrument with a photographing function according to the present invention, which is further constituted as a binocular telescope with a digital camera.

As shown in FIG. 17, in the third embodiment, the binocular telescope with the digital camera comprises a pair of lens barrels 38R and 138L for accommodating a right telescopic lens system 139R and a left telescopic lens system 139L, which are provided for the right and left eyes of a human. The right lens barrel 138R includes a main lens barrel section 140R and a movable lens barrel section 142R associated with each other. Similarly, the left lens barrel 138L includes a main lens barrel section 140L and a movable lens barrel section 142L associated with each other.

The right telescopic lens system 139R includes an objective lens system 144R, an erecting prism system 146R, and an ocular lens system 148R, and the left telescopic lens system 139L includes an objective lens system 144L, an erecting prism system 146L, and an ocular lens system 148L. Note, in FIG. 17, both of the erecting prism systems 146R and 146L are represented by a block illustrated by a one-dot chain line.

The objective lens system 144R and the erecting prism system 146R are housed in the main lens barrel section 140R. On the other hand, the ocular lens system 148R is housed in a sleeve member 150R, and this sleeve member 150R is slidably received in the movable lens barrel section 142R. The main lens barrel section 140R has a helicoid screw 152R formed around an inner wall surface of a rear end portion thereof, and the movable lens barrel section 142R has a helicoid screw 154R formed around an outer wall surface of a front end portion thereof. Namely, the movable lens barrel section 142R is assembled in the rear end portion of the main lens barrel section 140R such that the helicoid screws 152R and 154R are engaged with each other. Thus, when the movable lens barrel section 142R is rotated, the ocular lens system 148R is moved back and forth with respect to the objective lens system 144R, whereby an object to be observed through the right telescopic lens system 139R can be brought into focus. In short, both the helicoid screws 152R and 154R form a focusing mechanism for the right telescopic lens system 139R.

Similarly, the objective lens system 144L and the erecting prism system 146L are housed in the main lens barrel section 140L. The ocular lens system 148L is housed in a sleeve member 150L, and this sleeve member 150L is slidably received in the movable lens barrel section 142L. The main lens barrel section 140L has a helicoid screw 152L formed around an inner wall surface of a rear end portion thereof, and the movable lens barrel section 142L has a helicoid screw 154L formed around an outer wall surface of a front end portion thereof. Namely, the movable lens barrel section 142L is assembled in the rear end portion of the main lens barrel section 140L such that the helicoid screws 152L and 154L are engaged with each other. Thus, when the movable lens barrel section 142L is rotated, the ocular lens system 148L is moved back and forth with respect to the objective lens system 144L, whereby an object to be observed through the left telescopic lens system 139L can be brought into focus. In short, both the helicoid screws 152L and 154L form a focusing mechanism for the left telescopic lens system 139L.

Although each of the sleeve members 150R and 150L is movable with respect to the corresponding movable lens barrel section (142R, 142L) due to the slidable receipt of in the corresponding lens barrel section (142R, 142L), each sleeve member (150R, 150L) cannot be imprudently and indiscriminately moved, because there is a grease exhibiting a high viscosity between the sliding surfaces of each sleeve member (150R, 150L) and the corresponding lens barrel section (142R, 142L). Thus, by moving each sleeve member (150R, 150L) with respect to the corresponding lens barrel section (142R, 142L), it is possible to adjust a dioptric power in accordance with a visual power of the human's eye.

In order to simultaneously rotate the movable lens barrel sections 142R and 142L, a tubular shaft 156 is provided between the lens barrels 138R and 138L, and a rear end portion of the tubular shaft 156 is formed as a gear wheel 158. On the other hand, a rear end portion of each movable lens barrel section (142R, 142L) is formed as a gear wheel (160R, 160L), and the respective gear wheels 160R and 160L are operationally connected to the gear wheel 158 of the tubular shaft 156 through the intermediary of planet gear wheels 162R and 162L provided therebetween. Namely, the planet gear wheel 162R is meshed with both the gear wheels 158 and 160R, and the planet gear wheel 162L is meshed with both the gear wheels 158 and 160L. With this arrangement, both the movable lens barrel sections 142R and 142L can be simultaneously rotated by rotating the tubular shaft 156, and thus it is possible to synchronize the focussing of the right telescopic lens system 139R and the focussing of the left telescopic lens system 1391 with each other.

Although not shown in FIG. 1 to avoid an overly complex illustration, the binocular telescope with the digital camera comprises a right structural frame for supporting the right lens barrel 138R, a left structural frame for supporting the left lens barrel 138L, a common shaft to which the right and left structural frames are pivotally connected, and a central structural frame provided between the right and left structural frames to rotatably support the common shaft. Further, the respective planet gear wheels 162R and 162L are rotatably supported by the right and left structural frames, and the tubular shaft 156 is ratably supported by the central structural frame. With this arrangement, the right and left lens barrels 138R and 138L are rotatable around the common shaft to adjust the distance between the optical axes of the right and left telescopic lens systems 139R and 139L such that the distance can coincide with an interpupillary distance of a user. Namely, it is possible to perform the interpupillary adjustment by rotating the right and left lens barrels 138R and 138L around the common shaft.

As shown in FIGS. 17 and 18, a middle portion of the tubular shaft 156 is radially and integrally enlarged so as to form a rotary wheel 164, and the rotary wheel may be manually rotated by a user's finger. Namely, by manually operating the rotary wheel 164, it is possible to perform a manual focussing of both the right and left telescopic lens systems 139R and 139L.

As best shown in FIG. 18, a sleeve member 166 is inserted in and suitably secured to the tubular shaft 156 to thereby rotate together with the tubular shaft 156, and a lens barrel 168 is slidably received in the sleeve member 166. A photographing lens system 169 is housed in the lens barrel 168, and includes a first lens system 170 and a second lens system 172 associated with each other. The lens barrel 168 has a cam groove formed around an outer wall surface thereof, and the sleeve member 166 has a pin-like cam follower 174 which radially and inwardly protrudes from the inner wall surface thereof such that the pin-like cam follower 174 is engaged in the cam groove, as shown in FIG. 17.

Also, as shown in FIG. 18, a pair of key grooves 176 is diametrically formed in the front end portion of the sleeve member 166, and each key groove 176 extends over a predetermined distance measured from the front end edge thereof. On the other hand, a pair of pin elements 178 is diametrically provided on the front end of the lens barrel 168, and radially and outwardly protrudes so as to be engaged in the pair of key grooves 176. Thus, the lens barrel 168 is axially slidable in the sleeve member 166, but it cannot be rotated with respect to the sleeve member 166. As a result, when the tubular shaft 156 is rotated, the lens barrel 168 is axially moved in the sleeve member 166 due to the engagement of the pin-like cam follower 177 in the cam groove. In short, both the cam follower 177 and the cam groove form a focussing mechanism for the photographing lens system 169.

The cam groove is configured such that the lens barrel 168 is reversely moved with respect to the movement of both the movable lens barrel sections 142R and 142L. Namely, for example, when the tubular shaft 156 is rotated such that both the movable lens barrel sections 142R and 142L are moved forward, the lens barrel 168 is moved rearward.

As shown in FIG. 17, a half mirror 180 is provided in the main lens barrel section, and is disposed between the objective lens system 144R and the erecting prism system 146R to define an angle of 450 with respect to the optical axis of the right telescopic lens system 139R. Also, an opening 182 is formed in the side wall of the main lens barrel section 140R so as to be confronted by the half mirror 180, and a total reflecting mirror 184 is disposed outside so as to be parallel to the half mirror 180. In short, as shown in FIG. 17, the total reflecting mirror 184 is opposite to the half mirror 180 via the opening 192, and is disposed to define an angle of 450 with respect to the optical axis of the photographing lens system 169. Note, the total reflecting mirror 184 is suitably supported by the aforesaid center structural frame (not shown).

While a light beam carrying an object image is made incident on the objective lens system 144R, a part of the light beam passes through the half mirror 180 toward the erecting prism system 146R, and thus it is possible to observe the object through the ocular lens system 148R. On the other hand, the remaining part of the light beam is reflected by the half mirror 180 so as to be directed to the total reflecting mirror 184 via the opening 182, and is then made incident on the photographing lens system 169. Namely, in the third embodiment, the objective lens system 144R of the right telescopic lens system 139R forms a part of the photographing lens system 169.

As shown in FIGS. 17 and 18, a CCD image sensor 186 is arranged behind the tubular shaft 156, and is supported by the aforesaid central structural frame (not shown) such that a light-receiving surface of the CCD image sensor 186 is aligned with the photographing lens system 169 housed in the lens barrel 168. Thus, while an object is observed through both the right and left telescopic lens system 139R and 139L, the object is formed as an image to be photographed on the light-receiving surface of the CCD image sensor 186. In short, the photographing lens system 169 and the CCD image sensor 186 form the digital camera.

Similar to the first embodiment (FIGS. 1 to 8), in the third embodiment, when the binocular telescope with the digital camera is used as only a usual binocular telescope, it is possible to perform the focussing of both the right and left telescopic lens systems 139R and 139L by manually rotating the rotary wheel 164. However, when a photograph can be taken by using the contained digital camera, both the focussing of the right and left telescopic lens systems 139R and 139L and the focussing of the photographing lens system 169 must be automatically performed, because the focal depth of the photographing lens system 169 is very shallow.

To automatically perform the focussing of both the right and left telescopic lens systems 139R and 139L and the focussing of the photographing lens system 169, a part of the rotary wheel 164 is formed as a gear wheel 188, as best shown in FIG. 18. Further, a stepping motor 190 and an electromagnetic clutch 192 are arranged beside the tubular shaft 156, and are suitably supported by the aforesaid central structural frame. An output shaft of the stepping motor 190 is coupled to the electromagnetic clutch 192, and a gear wheel 194 is securely mounted on an output shaft of the electromagnetic clutch 192, and is engaged with the gear wheel 188 of the rotary wheel 164.

Although not shown in FIGS. 17 and 18, various switches are suitably arranged on, for example, the aforesaid right structural frame (not shown) for supporting the right main lens barrel section 140R. Among the various switches, there are a power ON/OFF switch, a release switch, and a mode selection switch, as explained with reference to FIG. 9 and FIG. 14. Also, although not shown in FIGS. 17 and 18, an LCD panel unit may be mounted on, for example, the aforesaid central structural frame.

Similar to the first embodiment, in the third embodiment, before the focusing of the photographing lens system 169 can be suitably and properly performed in the automatic focussing manner, the binocular telescope with the digital camera according to the third embodiment must be constituted such that the following conditions are fulfilled:

y²/[1000×PF(ω/T)²]>80 and F<6

Also, in the third embodiment, an automatic focussing operation may be performed in substantially the same manner as referred to in the flowchart shown in FIG. 10, FIG. 13 or FIG. 15.

In the above-mentioned embodiments, although the focussing mechanism for both the right and left telescopic lens systems (12R and 12L; 139R and 139L) and the focussing mechanism for the photographing lens system (67; 169) are operationally connected to each other, only the focussing mechanism for the photographing lens system may be operated in the automatic focussing manner. Of course, in this case, the focussing mechanism for both the right and left telescopic lens systems is operated at all times by manually driving the rotary wheel (56, 164). However, the focussing mechanism for both the right and left telescopic lens systems may be operated at all times in the automatic manner. In this case, there is no need for the rotary wheel (56, 164) and the electromagnetic clutch (102, 192).

Also, although the above-mentioned embodiments are directed to a binocular telescope containing a digital camera, the concept of the present invention may be embodied in another optical viewer instrument containing a digital camera, such as a single telescope containing a digital camera.

Finally, it will be understood by those skilled in the art that the foregoing description is of preferred embodiments of the instrument, and that various changes and modifications may be made to the present invention without departing from the spirit and scope thereof.

The present disclosure relates to subject matters contained in Japanese Patent Applications No. 2001-301783 (filed on Sep. 28, 2001), and No. 2002-014099 (filed on Jan. 23, 2002),which are expressly incorporated herein, by reference, in their entirety.

1. An optical viewer instrument with a photographing function, comprising:
a telescopic optical system including an optical objective system, an optical erecting system, and an optical ocular system to thereby observe an object, both said optical erecting and ocular systems being relatively movable with respect to said optical objective system along an optical axis of said telescopic optical system;
a tubular shaft rotatably provided beside said telescopic optical system;
a photographing optical system housed in said tubular shaft;
a first focussing mechanism that converts a rotational movement of said tubular shaft into a relative translational movement between both said optical erecting and ocular systems and said optical objective system to thereby bring the object into focus through said telescopic optical system;
a second focussing mechanism that converts the rotational movement of said tubular shaft into a translational movement of said photographing optical system to thereby focus the object through said photographing optical system;
a driving system that rotationally drives said tubular shaft; and
a focussing control system that controls said driving system such that the focussing of the object through said photographing optical system is automatically performed.

2. An optical viewer instrument with a photographing function as set forth in claim 1, further comprising a solid-state image sensor arranged behind and aligned with said photographing optical system such that the object is focussed on a light-receiving surface of said solid-state image sensor.

3. An optical viewer instrument with a photographing function as set forth in claim 2, wherein the following conditions are fulfilled:
y²/[1000×PF(ω/T)²]>80 and F<6
Herein:
“F” represents an f-number of the photographing optical system;
“y” represents a maximum image height (mm) of the solid-state image sensor, which is defined as one-half of a diagonal line length of the light-receiving surface of the solid-state image sensor;
“ω” represents a half field angle (rad) of the telescopic optical system;
“T” represents a field ratio of the half field angle “ω” to a half field angle “θ” (rad) of the photographing optical system (T=ω/θ); and
“P” represents a pixel pitch of the solid-state image sensor.

4. An optical viewer instrument with a photographing function as set forth in claim 2, wherein said focussing control system comprises:
a first calculation system that successively calculates a difference between brightness levels of two consecutive digital image-pixel signals derived from a predetermined area of one image frame defined by said solid-state image sensor;
a second calculation system that calculates a total value of all differences obtained from said first calculation system;
a calculation operation system that repeatedly operates said first and second calculation systems such that the total value is successively obtained from the second calculation system during the translational movement of said photographing optical system by said driving system;
a comparison system that compares a last total value, i.e. a total value calculated most recently, obtained from the second calculation system, with a penultimate total value, i.e. a total value calculated just before the last calculated total value, obtained from the second calculation system to determine whether the last total value is less than the penultimate total value; and
a stopping system that stops said driving system to end the translational movement of said photographing optical system when said last total value is less than the penultimate total value.

5. An optical viewer instrument with a photographing function as set forth in claim 2, wherein said focussing control system comprises:
a distance measurement detecting system that detects an object distance measured from the optical viewer instrument with the photographing function to the object;
a calculation system that calculates a focussed position of said photographing optical system, corresponding to said object distance detected by said distance measurement detecting system;
a position detecting system that detects a position of said photographing optical system along a path for the translational movement thereof;
a starting system that starts said driving system to translationally move said photographing optical system toward said focussed position calculated by said calculation system; and
a stopping system that stops said driving system to end the translational movement of said photographing optical system when an arrival of said photographing optical system at said focussed position is detected by said position detecting system.

6. An optical viewer instrument with a photographing function as set forth in claim 1, wherein said telescopic optical system is defined as a first telescopic optical system,
further comprising a second telescopic optical system including an optical objective system, an optical erecting system, and an optical ocular to thereby observe an object, both said optical erecting and ocular systems being relatively movable with respect to said optical objective system along an optical axis of said second telescopic optical system, said tubular shaft being disposed between said first and second telescopic optical systems, said first focussing mechanism further converting the rotational movement of said tubular shaft into a relative translational movement between both said optical erecting and ocular systems, included in said second telescopic optical system, and said optical objective system, included in said second telescopic optical system, to thereby bring the object into focus through said second telescopic optical system.

7. An optical viewer instrument with a photographing function as set forth in claim 6, further comprising a casing that accommodates said first and second telescopic optical systems, said casing including two casing sections movably engaged with each other, said respective first and second telescopic optical systems being assembled in said casing sections such that a distance between the optical axes of said first and second telescopic optical systems is adjustable by relatively moving one of said casing sections with respect to the remaining casing section.

8. An optical viewer instrument with a photographing function as set forth in claim 7, wherein one of said casing sections is slidably engaged in the remaining casing section such that the optical axes of said first and second telescopic optical systems are movable in a common geometric plane by relatively sliding one of said casing sections with respect to the remaining casing section.

9. An optical viewer instrument with a photographing function as set forth in claim 6, further comprising a pair of barrel members that accommodate said first and second telescopic optical systems, and that are rotatable around a central axis of said tubular shaft to adjust a distance between the optical axes of said first and second telescopic optical systems.

10. An optical viewer instrument with a photographing function as set forth in claim 9, wherein the objective optical system, included in one of said first and second telescopic optical systems, forms a part of said photographing optical system, and the barrel member accommodating said objective optical system forming the part of said photographing optical system is constituted such that a part of a light beam, passing through said objective optical system forming the part of said photographing optical system, is introduced into said photographing optical system.

11. An optical viewer instrument with a photographing function, comprising:
a telescopic optical system for observing an object;
a digital camera system including a photographing optical system, and a solid-state image sensor arranged behind and aligned with said photographing optical system;
a focussing mechanism associated with said photographing optical system to translationally move said photographing optical system such that the object is formed as a photographic image on a light-receiving surface of said solid-state image sensor through said photographing optical system; and
an automatic control system that automatically operates said focussing mechanism such that the object is brought into focus through said photographing optical system in an automatic focussing manner,
wherein the following conditions are fulfilled:
y²/[1000×PF(ω/T)²]>80 and F<6
Herein:
“F” represents an f-number of the photographing optical system;
“y” represents a maximum image height (mm) of the solid-state image sensor, which is defined as one-half of a diagonal line length of the light-receiving surface of the solid-state image sensor;
“ω” represents a half field angle (rad) of the telescopic optical system;
“T” represents a field ratio of the half field angle “ω” to a half field angle “θ” (rad) of the photographing optical system (T=ω/θ); and
“P” represents a pixel pitch of the solid-state image sensor.

12. An optical viewer instrument with a photographing function as set forth in claim 11, wherein said automatic control system comprises:
a driving system that operates said focussing mechanism to cause the translational movement of said photographing optical system;
a first calculation system that successively calculates a difference between brightness levels of two consecutive digital image-pixel signals derived from a predetermined area of one image frame defined by said solid-state image sensor;
a second calculation system that calculates a total value of all differences obtained from said first calculation system;
a calculation operation system that repeatedly operates said first and second calculation systems such that the total value is successively obtained from the second calculation system during the translational movement of said photographing optical system by said driving system;
a comparison system that compares a last total value, i.e. a total value calculated most recently, obtained from the second calculation system, with a penultimate total value, i.e. a total value calculated just before the last calculated total value, obtained from the second calculation system to determine whether the last total value is less than the penultimate total value; and
a stopping system that stops said driving system to end the translational movement of said photographing optical system when said last total value is less than the penultimate total value.

13. An optical viewer instrument with a photographing function as set forth in claim 11, wherein said automatic control system comprises:
a driving system that operates said focussing mechanism to cause the translational movement of said photographing optical system;
a distance measurement detecting system that detects an object distance measured from the optical viewer instrument with the photographing function to the object;
a calculation system that calculates a focussed position of said photographing optical system, corresponding to said object distance detected by said distance measurement detecting system;
a position detecting system that detects a position of said photographing optical system along a path for the translational movement thereof;
a starting system that starts said driving system to translationally move said photographing optical system toward said focussed position calculated by said calculation system; and
a stopping system that stops said driving system to end the translational movement of said photographing optical system when an arrival of said photographing optical system at said focussed position is detected by said position detecting system.

14. An optical viewer instrument with a photographing function as set forth in claim 11, further comprising a focussing mechanism associated with said telescopic optical system such that the object is brought into focus through said telescopic optical system, the focussing mechanism for said telescopic optical system being operationally connected to the focussing mechanism for said photographing optical system such that a focussing of said telescopic optical system is automatically performed.

15. An optical viewer instrument with a photographing function as set forth in claim 11, wherein said focussing mechanism for said photographing optical system is formed as a movement-conversion mechanism that converts a rotational movement into the translational movement of said photographing optical system such that a linear relationship is established between said rotational movement and the translational movement of said photographing optical system.

16. An optical viewer instrument with a photographing function as set forth in claim 11, wherein said focussing mechanism for said photographing optical system is formed as a movement-conversion mechanism that converts a rotational movement into the translational movement of said photographing optical system such that a nonlinear relationship is established between said rotational movement and the translational movement of said photographing optical system.

17. A binocular telescope with a photographing function, comprising:
a pair of telescopic optical systems for observing an object, each telescopic optical system including an optical objective system, an optical erecting system, and an optical ocular system, both said optical erecting and ocular systems being relatively movable with respect to said optical objective system along an optical axis of the corresponding telescopic optical system;
a tubular shaft rotatably provided between said telescopic optical systems;
a digital camera system including a photographing optical system housed in said tubular shaft, and a solid-state image sensor arranged behind and aligned with said photographing optical system;
a first focussing mechanism associated with said pair of telescopic optical systems and said tubular shaft such that a rotational movement of said tubular shaft is converted into a relative translational movement between both said optical erecting and ocular systems, included in each telescopic optical system, and said optical objective system, included in each telescopic optical system, to thereby bring the object into focus through said pair of telescopic optical systems;
a second focussing mechanism associated with said photographing optical system and said tubular shaft such that the rotational movement of said tubular shaft is converted into a translational movement of said photographing optical system with respect to a light-receiving surface of said solid-state image sensor, to thereby focus the object on the light-receiving surface of said solid-state image sensor; and
an automatic control system that automatically operates said second focussing mechanism such that the object is brought into focus through said photographing optical system in an automatic focussing manner,
wherein the following conditions are fulfilled:
y²/[1000PF(ω)/T)²]>80 and F<6
Herein:
“F” represents an f-number of the photographing optical system;
“y” represents a maximum image height (mm) of the solid-state image sensor, which is defined as one-half of a diagonal line length of the light-receiving surface of the solid-state image sensor;
“ω” represents a half field angle (rad) of the telescopic optical system;
“T” represents a field ratio of the half field angle “ω” to a half field angle “θ” (rad) of the photographing optical system (T=ω/θ); and
“P” represents a pixel pitch of the solid-state image sensor.

18. A binocular telescope with a photographing function as set forth in claim 17, wherein said automatic control system comprises:
a driving system that operates said focussing mechanism to cause the translational movement of said photographing optical system;
a first calculation system that successively calculates a difference between brightness levels of two consecutive digital image-pixel signals derived from a predetermined area of one image frame defined by said solid-state image sensor;
a second calculation system that calculates a total value of all differences obtained from said first: calculation system;
a calculation operation system that repeatedly operates said first and second calculation systems such that the total value is successively obtained from the second calculation system during the translational movement of said photographing optical system by said driving system;
a comparison system that compares a last total value, i.e. a total value calculated most recently, obtained from the second calculation system, with a penultimate total value, i.e. a total value calculated just before the last calculated total value, obtained from the second calculation system to determine whether the last total value is less than the penultimate total value; and
a stopping system that stops said driving system to end the translational movement of said photographing optical system when said last total value is less than the penultimate total value.

19. A binocular telescope with a photographing function as set forth in claim 17, wherein said automatic control system comprises:
a driving system that operates said focussing mechanism to cause the translational movement of said photographing optical system;
a distance measurement detecting system that detects an object distance measured from the optical viewer instrument with the photographing function to the object;
a calculation system that calculates a focussed position of said photographing optical system, corresponding to said object distance detected by said distance measurement detecting system;
a position detecting system that detects a position of said photographing optical system along a path for the translational movement thereof;
a starting system that starts said driving system to translationally move said photographing optical system toward said focussed position calculated by said calculation system; and
a stopping system that stops said driving system to end the translational movement of said photographing optical system when an arrival of said photographing optical system at said focussed position is detected by said position detecting system.

20. A binocular telescope with a photographing function as set forth in claim 17, wherein said first focussing mechanism for said pair of telescopic optical systems is operationally connected to the second focussing mechanism for said photographing optical system such that a focussing of said pair of telescopic optical systems is automatically performed.

21. A binocular telescope with a photographing function as set forth in claim 17, wherein said second focussing mechanism for said photographing optical system is formed as a movement-conversion mechanism that converts the rotational movement of said tubular shaft into the translational movement of the photographing optical system such that a linear relationship is established between the rotational movement of said tubular shaft and the translational movement of said photographing optical system.

22. A binocular telescope with a photographing function as set forth in claim 17, wherein said second focussing mechanism for said photographing optical system is formed as a movement-conversion mechanism that converts the rotational movement of said tubular shaft into the translational movement of the photographing optical system such that a nonlinear relationship is established between the rotational movement of said tubular shaft and the translational movement of said photographing optical system.

23. A binocular telescope with a photographing function as set forth in claim 17, further comprising a casing that receives said pair of telescopic optical systems, said casing including two casing sections movably engaged with each other, said respective telescopic optical systems being assembled in said casing sections such that a distance between the optical axes of said telescopic optical systems is adjustable by relatively moving one of said casing sections with respect to the remaining casing section.

24. A binocular telescope with a photographing function as set forth in claim 23, wherein one of said casing sections is slidably engaged in the remaining casing section such that the optical axes of said first and second telescopic optical systems are movable in a common geometric plane by relatively sliding one of said casing sections with respect to the remaining casing section.

25. A binocular telescope with a photographing function as set forth in claim 17, further comprising a pair of barrel members that accommodate said respective telescopic optical systems, and that are rotatable around a central axis of said tubular shaft to adjust a distance between the optical axes of said telescopic optical systems.

26. A binocular telescope with a photographing function as set forth in claim 25, wherein the objective optical system, included in one of said telescopic optical systems, forms a part of said photographing optical system, and the barrel member accommodating said objective optical system forming the part of said photographing optical system is constituted such that a part of a light beam, passing through said objective optical system forming the part of said photographing optical system, is introduced into said photographing optical system.
